(19) United States
(12) Patent Application Publication
(10) Pub. No.: US 2006/0036372 A1
(43) Pub. Date: Feb. 16, 2006

(54) Method and apparatus for tissue modeling

(76) Inventors: Bulent Yener, Canaan, NY (US); S. Humayun Gultekin, Portland, OR (US); Cigdem Gunduz, Troy, NY (US)

Correspondence Address: ARLEN L. OLSEN;SCHMEISER, OLSEN & WATTS, 3 LEAR JET LANE, SUITE 201, LATHAM, NY, 12110, US

(21) Appl. No.: 11/248,814

(22) Filed: Oct. 12, 2005

Related U.S. Application Data
(63) Continuation-in-part of application No. 11/082,412, filed on Mar. 17, 2005.
(60) Provisional application No. 60/554,107, filed on Mar. 18, 2004.
(60) Provisional application No. 60/618,819, filed on Oct. 14, 2004.

(51) Int. Cl. G06G 7/48; G06F 19/00

(52) U.S. Cl. 702/19; 703/11

(57) ABSTRACT

A method and apparatus for tissue modeling using at least one tissue image having cells therein and derived from biological tissue. Data derived from the tissue image is clustered to generate cluster vectors such that each cluster vector represents a portion of the tissue image. Cell information is generated which assigns a cell class or a background class to each of the cluster vectors. A cell-graph is generated for the tissue image from the generated cell information. The generated cell-graph comprises nodes and edges. The edges connect at least two of the nodes together. Each node represents at least one cell of the biological tissue or a portion of a single cell of the biological tissue. At least one metric may be computed from the nodes and edges, and the biological tissue may be classified based on the at least one metric.

### RELATED APPLICATION

The present invention is a continuation-in-part of copending United States patent application Ser. No. 11/082,412, filed Mar. 17, 2005 and entitled “Method and Apparatus For Tissue Modeling” and is incorporated herein by reference in its entirety and which claims priority to U.S. Provisional Application No. 60/554,107, filed Mar. 18, 2004 entitled “Cell-graphs: a method and apparatus for cancer modeling for noninvasive diagnosis”; and the present invention claims priority to U.S. Provisional Application No. 60/618,819, filed Oct. 14, 2004 entitled “Learning the topological properties of brain tumors” and is incorporated herein by reference in its entirety.”

### BACKGROUND OF THE INVENTION

1. Technical Field

The present invention relates to a method and apparatus for modeling cellular tissue to classify the tissue.

2. Related Art

Cancer is an uncontrolled proliferation of cells that express varying degrees of fidelity to their precursors. Neoplastic process entails not only cellular proliferation but also a modification of the differentiation of the involved cell types. Thus, in a sense cancer may be viewed as a burlesque of normal development. See E. Rubin and J. L. Farber, Pathology, 2nd Ed., Lippincott, Pa. 1994.

Diffuse malignant gliomas are cancerous brain tumors that invade the surrounding normal tissue by an aggressive diffusion process. This diffuse invasive behavior affects the prognosis adversely, and renders radical treatment impossible. Current mathematical models to quantify and analyze a cancer tumor are not scalable due to their enormous complexity.

Such diffuse gliomas possess the capability to infiltrate the surrounding healthy brain tissues by an initially non-destructive migrational manner. The biological basis for glioma invasion constitutes a complex process involving cell-to-cell interaction, adhesion to the exctracellular matrix, tumor cell motility, and enzymatic remodeling of the extracellular space. See P. Lantos, D. N. Louis, M. K. Rosenblum, P. Kleihuis, “Tumors of the Nervous System”, in Greenfield's Neuropathology, 7th Ed. Vol. 2 pp 767-1052 Eds: D. Graham & P. Lantos, Oxford University Press, London 2002. Although the state of art medical imaging improved the detection of gliomas; quantification of the extent of invasion, prediction of biological behavior, and radical surgical removal in individual cases remains a challenge.

Mathematical modeling of cancer and quantification of its properties has been a focus of intensive research. See Cancer Modeling ed: J. Thompson and B. Brown, Marcel Dekker, Inc.

1987. See also M. A. J. Chaplain, “The Mathematical Modelling of Tumor Angiogenesis and Invasion”. Acta Bzotheoret., 43:387-402, 1995. See also D. Drasdo, R. Kree and J. S. McCaskill, “Monte-Carlo Approach to Tissue Cell Populations”, Phys. Rev E, 52(6B):6635-6657, 1995. See also A. Anderson, M. Chaplain, E. Newman, R. Steele and A. Thompson, “Mathematical Modelling of Tumor Invasion and Metastasis”, J. Theor. Med. 2:129-165,2000. See also S. Turner and J. Sherratt, “Intercellular Adhesion and Cancer Invasion: A Discrete Simulation Using the Extended Potts model”, J. Theor. Biol., 216:85-100, 2002.

However, current computational and mathematical models at the cellular level are not scalable. Some of these approaches are based on Monte-Carlo algorithm. See D. Drasdo, R. Kree and J. S. McCaskill, “Monte-Carlo Approach to Tissue Cell Populations”, Phys. Rev E, 52(6B):6635-6657, 1995. See also S. Turner and J. Sherratt, “Intercellular Adhesion and Cancer Invasion: A Discrete Simulation Using the Extended Potts model”, J. Theor. Biol., 216:85-100, 2002.

Other computational and mathematical models are based on formulating continuous differential equations and finding probability generating functions to model the cell behavior. Clearly, solving large number of equations or simulating millions or billions of cells with Monte-Carlo algorithms has prohibitive computational complexity. Thus, addressing the scalability problem requires new algorithmic approaches and new models.

### SUMMARY OF THE INVENTION

The present invention provides a method for tissue modeling using at least one tissue image derived from biological tissue, said at least one tissue image having cells therein, said method comprising for each tissue image:
clustering data derived from the tissue image to generate cluster vectors such that each cluster vector represents a portion of the tissue image;
generating cell information, comprising assigning a cell class or a background class to each of the cluster vectors; and
generating a cell-graph for the tissue image from the generated cell information, said generating the cell-graph comprising generating nodes and edges of the cell-graph, said edges connecting at least two of the nodes together, each node representing at least one cell of the biological tissue or a collection of cells or a portion of a single cell of the biological tissue.

The present invention provides a computer program product, comprising a computer usable medium having a computer readable program code embodied therein, said computer readable program code comprising an algorithm adapted to implement a method for tissue modeling using at least one tissue image derived from biological tissue, said at least one tissue image having cells therein, clustering data having been derived from the tissue image to generate cluster vectors such that each cluster vector represents a portion of the tissue image, cell information having been generated by assignment of a cell class or a background class to each of the cluster vectors, said method comprising:
generating a cell-graph for the tissue image from the generated cell information, said generating the cell-graph comprising generating nodes and edges of the cell-graph, said edges connecting at least two of the nodes together, each node representing at least one cell of the biological tissue or a collection of cells or a portion of a single cell of the biological tissue.

The present invention provides an apparatus for tissue modeling using at least one tissue image derived from biological tissue, said at least one tissue image having cells therein, said apparatus comprising for each tissue image:
means for clustering data derived from the tissue image to generate cluster vectors such that each cluster vector represents a portion of the tissue image;
means for generating cell information, comprising assigning a cell class or a background class to each of the cluster vectors; and
means for generating a cell-graph for the tissue image from the generated cell information, said means for generating the cell-graph comprising means for generating nodes and edges of the cell-graph, said edges connecting at least two of the nodes together, each node representing at least one cell of the biological tissue or a collection of cells or a portion of a single cell of the biological tissue.

The present invention advantageously provides a method and apparatus for modeling cellular tissue using a graph theoretical model that is scalable.

### BRIEF DESCRIPTION OF THE DRAWINGS

FIG. 1A is a flow chart depicting methodology for modeling a tissue image derived from biological tissue, in accordance with embodiments of the present invention.

FIG. 1B illustrates pixels, grid entries, and nodes relating to a tissue image processed by the flow chart of FIG. 1A, in accordance with embodiments of the present invention.

FIG. 2 depicts a single perceptron, in accordance with embodiments of the present invention.

FIG. 3 depicts a multilayer network comprising perceptrons, in accordance with embodiments of the present invention.

FIGS. 4-5 depict images representing a methodology for graphically representing cells of biological tissue, in accordance with embodiments of the present invention.

FIG. 6 depicts cell-graphs representing cancer and normal cells, in accordance with embodiments of the present invention.

FIG. 7 depicts data histograms of metrics computed for the cell-graphs representing cancer and normal cells in FIG. 6, in accordance with embodiments of the present invention.

FIG. 8 depicts images and cell-graphs representing cancer and inflammation cells, in accordance with embodiments of the present invention.

FIG. 9 depicts data histograms of metrics computed for the image and cell-graphs representing cancer and inflammation cells in FIG. 8, in accordance with embodiments of the present invention.

FIG. 10 depicts data histograms of metrics computed for the cell-graphs representing cancer cells and for randomly generated cell-graphs, in accordance with embodiments of the present invention.

FIG. 11 depicts an image and graph of tissue containing both cancer and normal cells and a graph classifying cancer and normal cells within the image, in accordance with embodiments of the present invention.

FIG. 12 depicts image processing of cancerous tissue showing a cancerous glioma tissue image, in accordance with embodiments of the present invention.

FIG. 13 illustrates a comparison between normal tissue and cancer tissue, in accordance with embodiments of the present invention.

FIGS. 14 and 15 are plots of classification accuracy versus grid size for node-thresholds of 0.25 and 0.50, respectively, for classification of tissue samples using complete cell-graphs, in accordance with embodiments of the present invention.

FIG. 16 is a plot of classification accuracy versus node-threshold using 30-fold cross-validation with complete cell-graphs in accordance with embodiments of the present invention.

FIG. 17 illustrates features extracted from eigenvalues of a normalized Laplacian matrix, in accordance with embodiments of the present invention.

FIG. 18 is a table of first and second layer classifier accuracy as a function of a for the normalized Laplacian matrix spectra of the cell-graphs, in accordance with embodiments of the present invention.

FIG. 19 is a table of first and second layer classifier accuracy as a function of α for the adjaceny matrix spectra of the cell-graphs, in accordance with embodiments of the present invention.

FIG. 20 is a table of classifier accuracy for various spectral properties for the normalized Laplacian matrix spectra of the cell-graphs, in accordance with embodiments of the present invention.

FIG. 21 is a plot of the classification accuracy versus a when the second layer classifier uses only the connected component as its feature, in accordance with embodiments of the present invention.

FIG. 22 is a box and whisker plot which illustrates the distribution of the number of the connected components of the cell-graphs for malignant and benign classes, in accordance with embodiments of the present invention.

FIG. 23 depicts images illustrating differences in tissue samples and their associated cell-graphs, in accordance with embodiments of the present invention.

FIG. 24 is a flow chart depicting methodology for tissue modeling, in accordance with embodiments of the present invention.

FIG. 25 depicts images representing a methodology for graphically representing cells of biological tissue, in accordance with embodiments of the present invention.

FIG. 26 illustrates a computer system used for tissue modeling, in accordance with embodiments of the present invention.

### DETAILED DESCRIPTION OF THE INVENTION

The detailed description of the present invention is organized into the following sections:
1. Cell Graphs With Local Metrics
2. Cell Graphs With Global Metrics
3. Cell Graphs With Weighted Edges
4. Spectral Analysis of Cell Graphs
5. Automated Tissue Diagnosis
   1. Cell Graphs with Local Metrics
   1.1 Introduction

The present invention provides novel mathematical techniques to model biological tissue in order to classify the biological tissue, including modeling of a cancer tumor and quantifying the properties of the invasion of biological tissue by cancer cells. The present invention uses a macroscopic modeling, rather than cellular modeling, in which tissue is represented by graphs and each node can represent a bunch of cells instead of a single cell.

Although the analysis of experimental data for the embodiments described herein pertains to the classification of clinical tissue from human subjects, the scope of the present invention is generally applicable to any type of biological tissue, including animal tissue and plant tissue. The animal tissue may relate to tissue of a mammal (e.g., a human being, a non-human animal such as a monkey, etc.). The animal may be a veterinary animal, which is a non-human animal of any kind such as, inter alia, a domestic animal (e.g., dog, cat, etc.), a farm animal (cow, sheep, pig, etc.), a wild animal (e.g., a deer, fox, etc.), a laboratory animal (e.g., mouse, rat, monkey, etc.), an aquatic animal (e.g., a fish, turtle, etc.), etc. Differentiated cellular topology in any type of biological tissue may be analyzed and classified by the methods of the present invention described herein.

A machine learning algorithm of the present invention uses a scalable, graph theoretical model, based on examination of the coordinates of individual cells in a sample tissue to construct a cell-graph for determining a spatial relationship between the cells of biological tissue. The mathematical properties of the cell-graph are computed by the machine learning algorithm to identify subgraphs that represent different biomedical phenomena in the sample tissue. The machine learning algorithm is trained over numerous samples under human (expert) supervision. The machine learning algorithm uses graph metrics to distinguish tissue types or characteristics; e.g., to distinguish: (i) gliomas from surrounding normal tissue; and (ii) gliomas from other invasions such as inflammation. The machine learning algorithm has been tested, using real data derived from tissue samples, to validate the methodology of the present invention.

The graph theoretical approach of the present invention is motivated by the fact that many real-world, self-organizing, complex dynamic systems can be represented by graphs. Furthermore, precise metrics are available to quantify the properties of these graphs in such systems and identify their characteristics. One example is the Hollywood movie star network, obtained by drawing a line between two actors if they played in the same movie. This network is derived from 150,000 movies and has 300,000 nodes. Another example is the World Wide Web (WWW) graph in which each page is a node and each Universal Resource Locator (URL) is a directed link. This WWW graph has billions of nodes and several billions of links (it was based on 1999 data). Similarly, the Internet router graph has hundreds of thousands nodes and links. Another example is the USA power grid network which has approximately 5,000 nodes. A collaboration network among the mathematicians with 70,000 nodes and 200,000 links (1991-1998 data) is another example. In addition, the tiny neural network of C-elegance worm with 300 nodes (neurons) shares common properties with the earlier mentioned, much large networks. Although the size and domains of these graphs are very different, it is possible to distinguish them from random graphs (see B. Bollabas, Random Graphs (Academic Press, London, 1985)) using some of the metrics that are adapted in this work as well.

The approach of the present invention is based on construction of cell-graphs from the tissue images. A cell-graph is denoted by G=(V, E) where the vertex (node) set represents the nucleus of cells and the edge set E defines a locality relationship between the nodes.

The results described infra herein demonstrate that a cell-graph derived from sample tissue images and deployment of a machine learning algorithm distinguishes between different regions in the tissue based on the graph metrics. The graph theoretical model of the present invention is scalable, since graphs with order of millions nodes can be tackled to compute the metrics of interest.

1.2 Formalism and Methodology

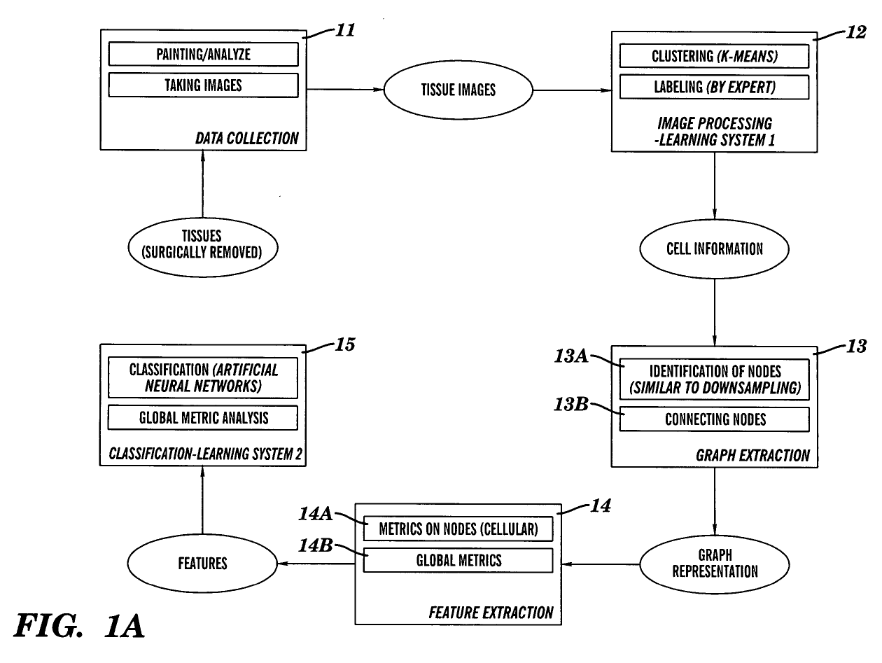

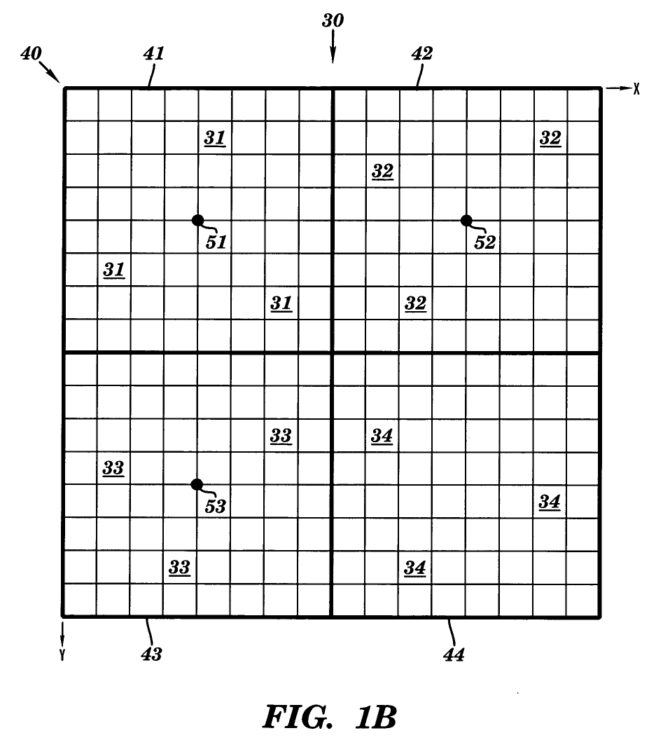

FIG. 1A is a flow chart depicting a method for modeling a tissue image derived from biological tissue, in accordance with embodiments of the present invention. The flow chart of FIG. 1A comprises steps 11-15.

Step 11 (“Data collection”) obtains tissue images derived from surgically removed clinical tissue from patients. A staining process enables the tissue images to be seen under a microscope. Using these images of tissue sample s, the inventive tool of steps 12-15 distinguishes and recognize different type of cells; e.g., healthy, cancer, or inflamed cells.

Step 12 (“Image processing—learning system”), called “color quantization,” determines the cell locations in a tissue image by distinguishing the cells from their background. A K-means clustering algorithm, based on the color information of the pixels in the tissue image (see J. A. Hartigan and M. A. Wong, “A K-Means Clustering Algorithm”, Applied Statistics, vol. 28, pp. 100-108,1979; Advances in Physics, cond-mat/0106144, 2002), is used.

The K-means clustering algorithm is an unsupervised learning algorithm that clusters the data based on their features. See J. A. Hartigan and M. A. Wong, “A K-Means Clustering Algorithm”, Applied Statistics, vol. 28, pp. 100-108,1979; Advances in Physics, cond-mat/0106144, 2002. The K-means algorithm is applied to K cluster vectors and each sample belongs to one of the clusters whose center is the closest to that sample. After assigning the sample to one of the clusters, the sample is represented by this cluster vector.

The K-means algorithm is trained as to minimize the distances between the samples and their corresponding cluster vectors. Beginning with random cluster vectors, and after assigning each sample to its closest vector, cluster vectors are recomputed as the mean of all samples that belong to them. This continues iteratively until reaching a convergence point.

The K-means algorithm is used to cluster the color information of the tissue images, where the clustered color information is represented by red-green-blue (RGB) values. Each cluster vector, which is also composed of RGB values, represents the group of colors.

There are K cluster vectors and each sample is assigned to its closest cluster and is represented with this clustering vector. For example, the samples that are to be clustered may be the color values of the pixels (e.g., RGB values). The distance between a sample and a cluster can be measured as the sum of the absolute differences between their corresponding features or alternatively as the sum of the squares of these differences. In training, the K-means algorithm determines the clustering vectors as to minimize the sum of these distances between each sample and its corresponding clustering vector. Formally, for a data set X={xᵢ} with a size of N, the K-means algorithm aims to minimize the following error function E:

$$E = {\sum }_{i = 1}^{N} {\sum }_{j = 1}^{d} {( {C}_{kj} - {x}_{ij} )}^{2} , where {x}_{i} ∈ {C}_{k}$$

where N and d indicate the number of samples in the data set X and the number of the features of these samples, respectively. Here Cₖ indicates the K^{th} clustering vector.

After setting the cluster vectors on training samples, a pathology expert analyzes the cluster information and assigns classes to the cluster vectors; i.e., the pathology expert labels these clusters as one (“1”) for cell regions, or as zero (“0”) for background (i.e., non-cell) regions. Thus, each pixel of a cluster labeled as “1” is assigned a value of 1, and each pixel of a cluster labeled as “0” is assigned a value of 0. These labeled clusters are used in the tissue samples during testing.

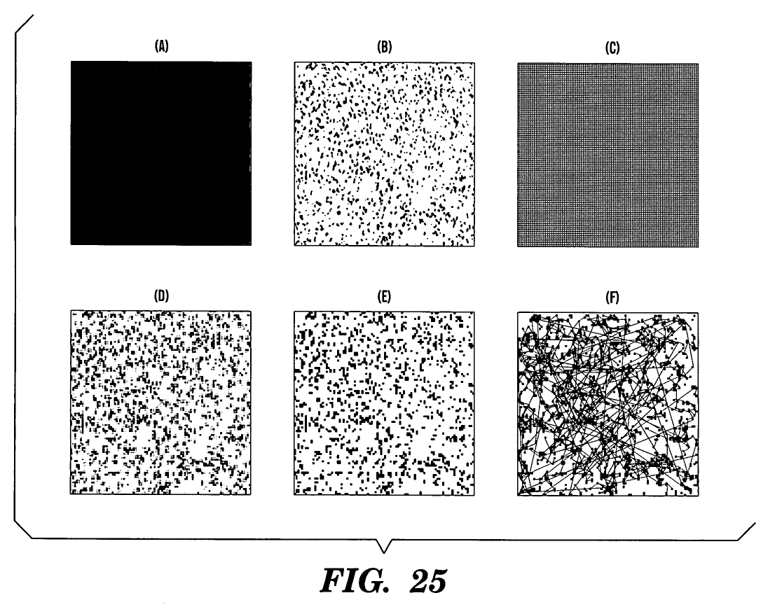

The tissue image is represented as an array of pixels and each pixel is assigned 1 or 0 if said pixel is in a labeled cell region or in the labeled background, respectively. See infra FIG. 25(b) for a pictorial representation of black and white pixels having assigned values of 1 and 0, respectively.

Step 13 (“Graph extraction”) transforms the cell information to identify the nodes (also called “cell-nodes” or “vertices”) of the graph in a “node identification” step 13A. A potential difficulty is noise, since in glioma samples there are too many cells with different sizes as well as coinciding cells. The noise prevents a one-to-one mapping between a cell and a node. Moreover, if a one-to-one mapping were possible, then the number of nodes in the graph would be dependent on the number of cells, which makes the computation hard for very large tissue cells.

The present invention approaches the aforementioned problem by having the transformation of the cell information in step 13 embed (i.e., overlay) a two-dimensional grid over the sample image of pixels and calculate the probability of a grid entry being a cell. A grid entry is a grid box of the two-dimensional grid. For example a 80×80 grid has 6400 grid entries or 6400 grid boxes.

The two-dimensional grid is defined by mesh points that determine the grid boxes. For example a 80×80 grid has 6400 grid boxes as defined by 81 mesh points in each of two orthogonal directions. Denoting X and Y as orthogonal coordinate axes for representing the two-dimensional grid, the mesh points of the grid may be: (1) uniformly spaced in both the X and Y directions; (2) non-uniformly spaced in both the X and Y directions; or (3) uniformly spaced in one direction (e.g., the X direction) and non-uniformly spaced in the other direction (e.g., the Y direction). If the mesh points of the grid are uniformly spaced in both the X and Y directions, then the grid may be characterized by a “grid size” defined as the constant number of pixels in each dimension of a grid entry. The grid entries used in this method are square except those in the borders of the tissue image. For example, if the tissue image is represented by a 480×480 array of pixels (i.e., 230,400 pixels) then a 80×80 grid (i.e., 6400 grid entries) has an associated grid size of 6 (i.e., (480/80) and a grid entry of 6×6.

For each grid entry, the probability value P_{C} of the grid entry being a cell is computed as the average value (1 or 0) of the label of pixels located in this grid entry. A threshold (i.e., node-threshold) is applied to the computed probability value for each grid entry and the computed probability values greater than the node-threshold are labeled as cell, whereas the other computed probability values are labeled as background. The labeling of cells and background is governed by two control parameters, namely: (i) the grid size; and (ii) the node-threshold value. The labeling of a grid entry as “cell” defines a node of the cell-graph as being at the center of the grid entry. Those grid entries labeled as “background” do not define nodes of the cell-graph.

FIG. 1B illustrates pixels, grid entries, and nodes relating to a tissue image 30 processed by the flow chart of FIG. 1A, in accordance with embodiments of the present invention. The tissue image 30 comprises a 16×16 array of pixels with respect to orthogonal coordinate axes X and Y. A grid overlay 40 comprises grid entries 41-44, each grid entry having a 8×8 array of pixels therein. Thus, each grid entry has a grid size of 8. Grid entry 41 comprises the 8×8 array of pixels 31. Grid entry 42 comprises the 8×8 array of pixels 32. Grid entry 43 comprises the 8×8 array of pixels 33. Grid entry 44 comprises the 8×8 array of pixels 34.

In FIG. 1B, grid entry 41 is assumed to be labeled as cell based on having a computed probability value greater than the node-threshold. Thus, the labeling of grid entry 41 as cell defines a node 51 located at the center of grid entry 41. Similarly, grid entries 42 and 43 are likewise assumed to be labeled as cell based on satisfying the node-threshold test and therefore define a node 52 and 53 located at the center of grid entry 42 and 43, respectively. Grid entry 44 is assumed to be labeled as background based on having a computed probability value not greater than the node-threshold. Thus, the labeling of grid entry 44 as background does not define a node for grid entry 44. Therefore, the cell-graph associated with FIG. 1B has nodes 51-53.

Use of the two-dimensional grid may be considered as a downsampling of the image obtained in step 12. Increasing the node-threshold value produces sparser graphs, and the grid size determines the downsampling rate. Note that the resolution of a tissue image determines the complexity of whole process.

Thus, the labeling of the grid entries as cell or background translates the spatial information of the nodes to their locations on the two-dimensional grid. After the nodes are translated to their locations on the two-dimensional grid, edges (also called “cell-edges” or “links”) are defined to connect the nodes to construct the graph in an “edge establishing” step 13B. Defining the edges uses the spatial relationships (including (x,y) coordinate locations) of the nodes in the two-dimensional grid. For example, any two nodes are to be connected by an edge if the distance (i.e., the Euclidean distance) between the two nodes is smaller than a predefined edge-threshold. Thus, the edge-threshold affects the connectivity of the graph. Increasing the edge-threshold results in denser graphs. The edges determined in the preceding manner have equal weights for computing metrics of the cell-graph.

In summary, the generation of the cell-graph comprises the steps of color quantization (step 12), node identification (step 13A), and edge establishing (step 13B).

Step 14 (“Feature extraction”) computes six different metrics on the resultant graphs, reflecting the different topological properties of the graphs and providing information of its characteristics. The metrics defined herein may be used in analyzing the other types of graphs, e.g., Internet, actor or C-elegance worm graphs. These metrics quantify the information about the degree distribution of a node, the connectivity information of its neighbors, and the connectedness information of itself as well as the whole graph. The metrics defined on the nodes may be local metrics (step 14A) or global metrics (step 14B) (see Section 2 described infra for a discussion of global metrics). Note that a metric computed on a single node is a local metric. In contrast, a global metric reflects the properties of the entire graph. Thus, the local metrics of all of the nodes may be used to define global metrics. For example, a global metric may be computed as the mean of the local metrics, the maximum of the local metrics, etc.

In relation to step 14A, six local metrics identified in this section are used to identify and distinguish mathematical properties of gliomas from other cell structures. The six local metrics are: degree, node-excluding clustering coefficient Cᵢ, node-including clustering coefficient Dᵢ, closeness, betweenness, and eccentricity.

The “degree” metric is defined as the number of the connections of a single node to other neighbor nodes for an undirected graph. The degree value may be higher on a tumor graph than on a normal graph, but higher degree values are not always an indicator of a cancer.

A clustering coefficient reflects the connectivity information in the neighborhood environment of a node. See S. N. Dorogovtsev and J. F. F. iilendes, “Evolution of Networks”, Advances in Physics, cond-mat/0106144, 2002. The clustering coefficients provide the transitivity information (see M. E. J. Newman, “Who is the Best Connected Scientist? A Study of Scientific Coauthorship Networks”, Phys.Rev., cond-mat/O011144, 2001), since a clustering coefficient controls whether two different nodes are connected or not, if they are connected to the same node. The present invention utilizes clustering coefficients Cᵢ and Dᵢ.

The node-excluding clustering coefficient Cᵢ is defined as the percentage of the connections between the neighbors of node i, and is given as
Cᵢ=2Eᵢ/(k·(k−1)) (1)
where k is the number of neighbors of node i, and Eᵢ is the existing connections among the k neighbors of node i. Note that k·(k−1)/2 denotes the total number of node combinations derived from the k neighbor nodes subject to each node combination consisting of two nodes of the k nodes.

Random and scale-free graphs can be distinguished by using the clustering coefficient C. Random graphs have small values of clustering coefficients C, whereas scale-free graphs have larger values than those of the random graphs. The inventors of the present invention have observed larger values for their tissue images, which indicates the scale-free-ness of the graphs and also demonstrates that the cell-graphs are not random.

The node-including clustering coefficient Dᵢ is a modified version of the clustering coefficient defined in S. N. Dorogovtsev and J. F. F. iilendes, “Evolution of Networks”, Advances in Physics, cond-mat/0106144, 2002. Clustering coefficient Dᵢ, which is similar to Cᵢ with an exception of taking into account node i and its connections, is given as:
Dᵢ=2·(Eᵢ+k)/(k·(k+1)) (2)

“Closeness” and “betweenness” are local metrics that measure the connectedness of a graph. See M. E. J. Newman, “Who is the Best Connected Scientist? A Study of Scientific Coauthorship Networks”, Phys.Rev., cond-mat/O011144, 2001.

The closeness of a node is the average of the distances between the node and every other nodes except itself. Closeness reflects the centrality property of a single node and smaller values indicate that this node places close to the center of a graph.

Betweenness of a node is the total number of the shortest paths that pass through the node. These metrics may indicate the location of a cell within the tumor. For example, having a smaller closeness value or higher betweenness value may suggest that the cell is close to the center of the tumor.

“Eccentricity” of a node is a local metric defined as the minimum number of hops (i.e., edges) from a node i required to reach at least 90 percent of the reachable nodes from node i. Higher values of this eccentricity metric may indicate the density of the diffuse invasion.

Step 15 of FIG. 1A (“Classification”) executes a machine learning algorithm, using the metrics computed in step 14 as input, to classify different cell concentrations as cancerous, normal, or inflammation. The machine learning algorithm may employ artificial neural networks.

A neural network comprises nodes, called “perceptrons”, that are tied with weighted connections. Each perceptron takes a vector of input values and computes a single output value as the weighted sum of its input values. The output value is activated only if the output value exceeds the threshold defined by an activation function. See C. M. Bishop, Neural Networks for Pattern Recognition, Oxford University Press, 1995. See also A. K. Jain, J. Mao and K. M. Mohiuddin, “Artificial Neural Networks: A Tutorial”, Computer, Vol. 29, No. 3, pp. 31-44, 1996.

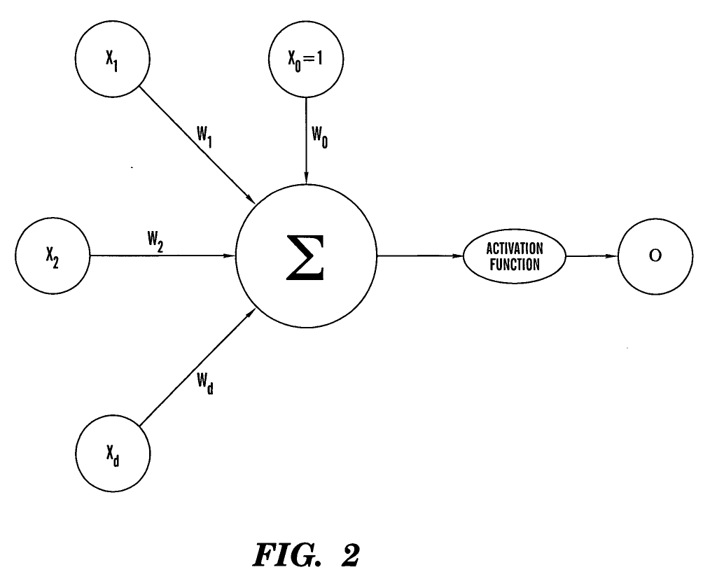

FIG. 2 depicts a single perceptron inputs xᵢ and output (o), in accordance with embodiments of the present invention. Weights wᵢ are associated with each input xᵢ, where wₒ is a bias term. The present invention uses multilayer perceptrons (MLPs). In multilayer perceptrons, the outputs of each layer are connected to the inputs of another layer. The inputs, xᵢ are the topological metrics and the output (o) is the class label, indicating whether a cell is cancerous, healthy, or generated as synthetically. The input layer is connected to a hidden layer with weights wᵢⱼ and the hidden layer connects to an output layer with weights vᵢⱼ.

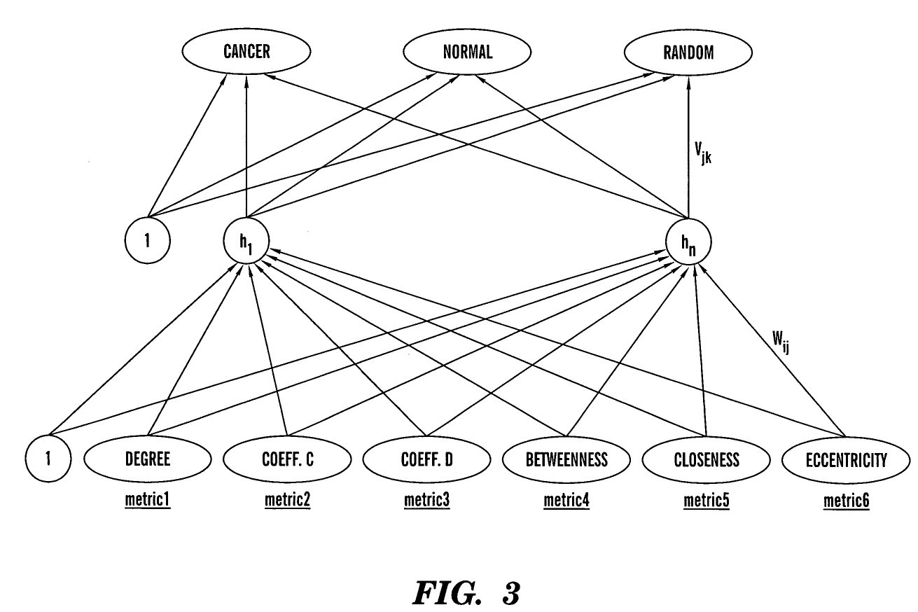

FIG. 3 depicts a multilayer network comprising perceptrons, in accordance with embodiments of the present invention. The inputs are the local metrics defined for the nodes of the extracted graphs. The output indicates whether a cell is cancerous, healthy, or generated synthetically. The outputted cell classification makes use of the six different local metrics, described supra.

1.3 Experiments

Experiments were conducted on clinical data for brain tumors, wherein the digital images of surgically removed tissues were used to construct a graph representing the data as explained supra. Each pixel of these images is represented by its RGB values.

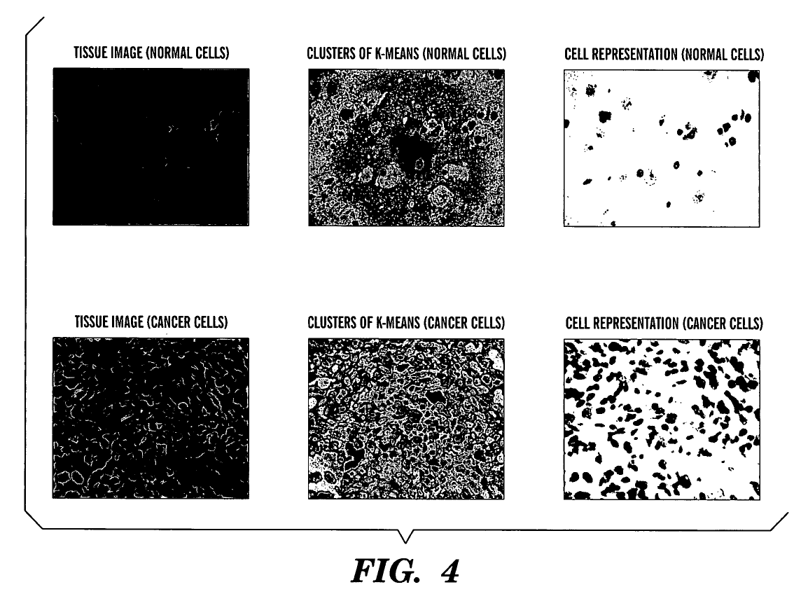

FIGS. 4-5 depict images representing a methodology for graphically representing cells of surgically removed tissue, in accordance with embodiments of the present invention.

FIG. 4 illustrates step 12 of FIG. 1a in which cell information is extracted from the surgically removed tissue. The K-means algorithm (described supra) was run on the data to learn cluster vectors on training samples. These cluster values are used for the test samples. Various K values were tried, and based on the clusters and based on human expertise, the clusters were labeled as either cell or background. FIG. 4 illustrates these steps for both cancer and normal tissues. The images in this graph in FIG. 4 are from the test set and are not used in training. The value of K is selected as 17 in this graph in FIG. 4.

After determining the cell and background regions as discussed supra in conjunction with FIG. 4, the nodes are to be extracted on these data, as illustrated in FIG. 5 in relation to step 13A of FIG. 1A. A tissue image having cancer cells therein and the tissue cell representation are depicted in FIGS. 5(a) and 5(b), respectively. In FIG. 5(c), a grid has been embedded on the cell representation of FIG. 5(b). For each entry of a grid of FIG. 5(c), a probability value of the grid entry being a cell (rather than background) is computed by averaging the assigned data in the pixels within the grid entry. Note that cell regions (and associated pixels) are labeled as 1, and the background (and associated pixels) are labeled as 0, so that the computed probability value P_{C} is the average of the labeled values of 1 and 0 in the grid entry. Grid entries with probability values greater than a node-threshold are considered as the nodes of a cell graph. In this step, a node can represent a single cell, a part of a cell, or bunch of cells depending on the grid size. FIG. 5(d) uses gray scale levels to represent the average values.

The nodes so determined are weighted equally. Section 3 infra presents alternative embodiments for step 13A of FIG. 1A in which the nodes are selectively weighted based on the probability P_{C} as determined by the cell cluster size.

To selectively establish edges (also called “links”) between the nodes in relation to step 13B of FIG. 1A, the cells of each pair of cells of FIG. 5(d) are connected if the distance between said cells is smaller than an edge-threshold, as shown in FIG. 5(e).

These three parameters are set as follows: the grid size=50 (i.e., 50×50 pixels of each grid entry are grouped to represent a cell or not); the node-threshold=0.1 (i.e., at least 10 percent of a grid entry should consist of cell regions to being a cell); and the edge-threshold=1 (i.e., two nodes are to be connected if they are adjacent in the grid). The resultant graph representation is shown in FIG. 5(f).

The edges in the edge establishing step illustrated in FIG. 5(d) may be established probabilistically. The probability of an existence of an edge E(u,v) between nodes u and v of a representative pair of nodes is given by
P(u,v)=d(u,v)^{-α} (3)
wherein α>0, wherein d(u,v) is the Euclidean distance between the nodes u and v, and wherein a controls the number of edges of the cell-graph. In measuring the Euclidean distance, the grid size is taken as a unit length. This probability P(u,v) quantifies the possibility for one of these nodes (v) to be grown from the other (u). After determining the nodes in the node identification step 13A, the edge E(u,v) between the nodes u and v is assigned if
r<d(u,v)^{-α} (4)
wherein r is an edge probability threshold that is a real number between 0 and 1. Each pair of nodes of the cell-graph is assigned an edge if Equation (4) is satisfied for said each pair of nodes. In one embodiment, r is generated by a random number generator (e.g., r may be randomly selected from a uniform probability distribution between 0 and 1). Since α>0, the function d(u,v)^{-α} has a value between 0 and 1. The value of α determines the density of the edges in a cell-graph, wherein larger values of α produce sparser graphs.

Section 3 infra presents alternative embodiments for step 13B of FIG. 1A in which all nodes have edges therebetween, wherein the edges are selectively weighted based on the Euclidean distance between the nodes connected by the edge. In the alternative embodiments of Section 3, the use of variable edge weights replace the probabilistic formulation of Equations (3) and (4), thereby eliminating the need to assign a value of α.

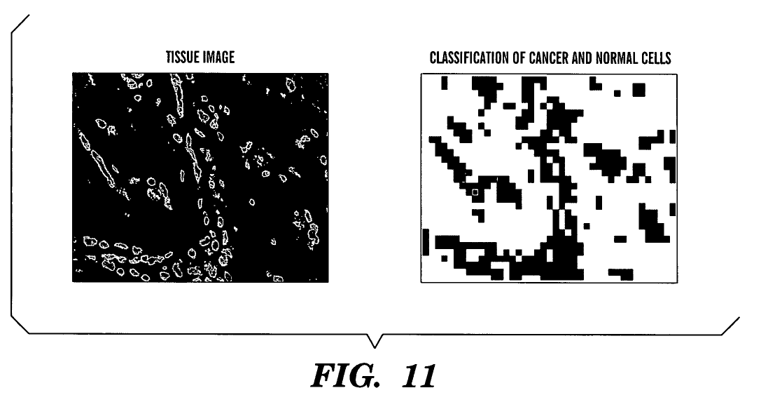

FIG. 12 depicts image processing of cancerous tissue showing a cancerous glioma tissue image (FIG. 12(a)), clusters resulting from application of a K-means algorithm with K=9 (FIG. 12(b)), and cells and the background as labeled by a pathology expert, in accordance with embodiments of the present invention.

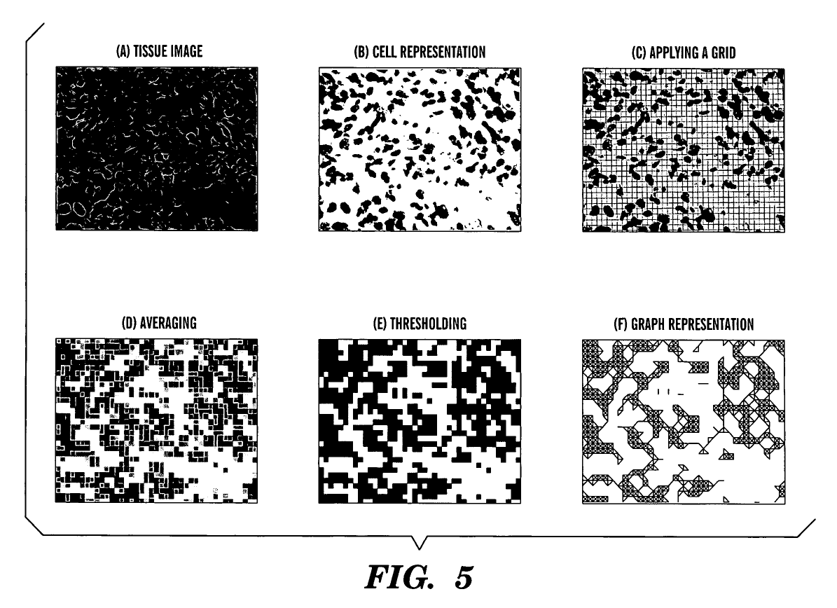

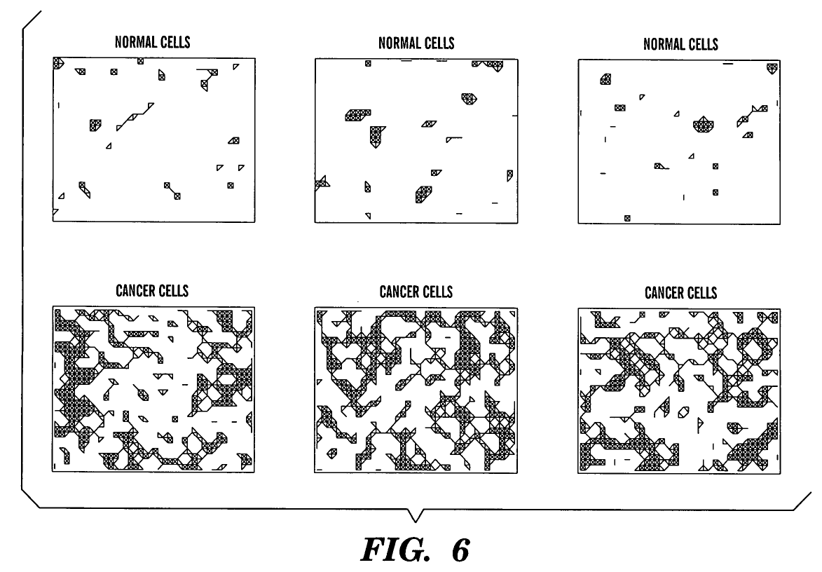

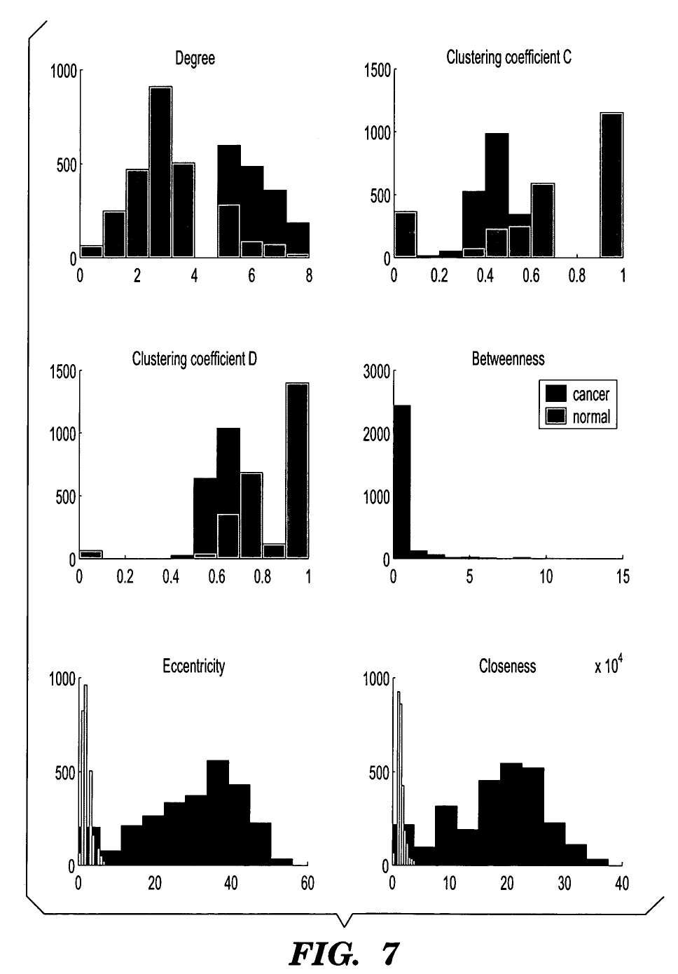

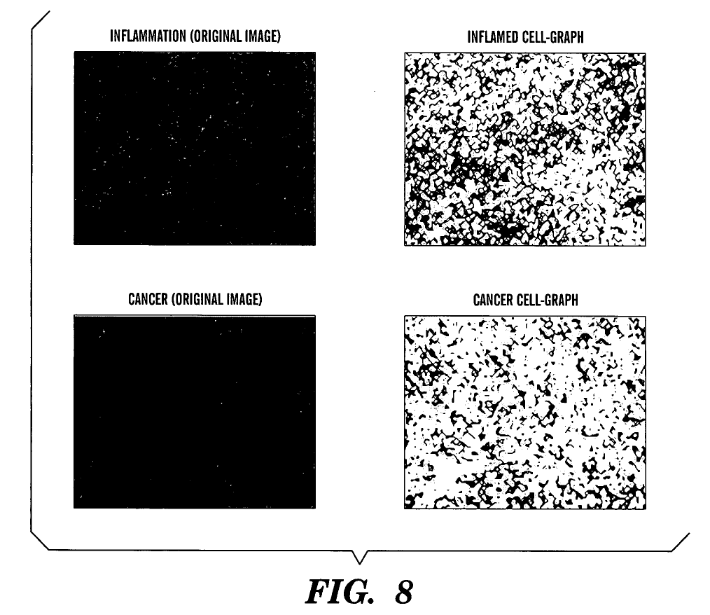

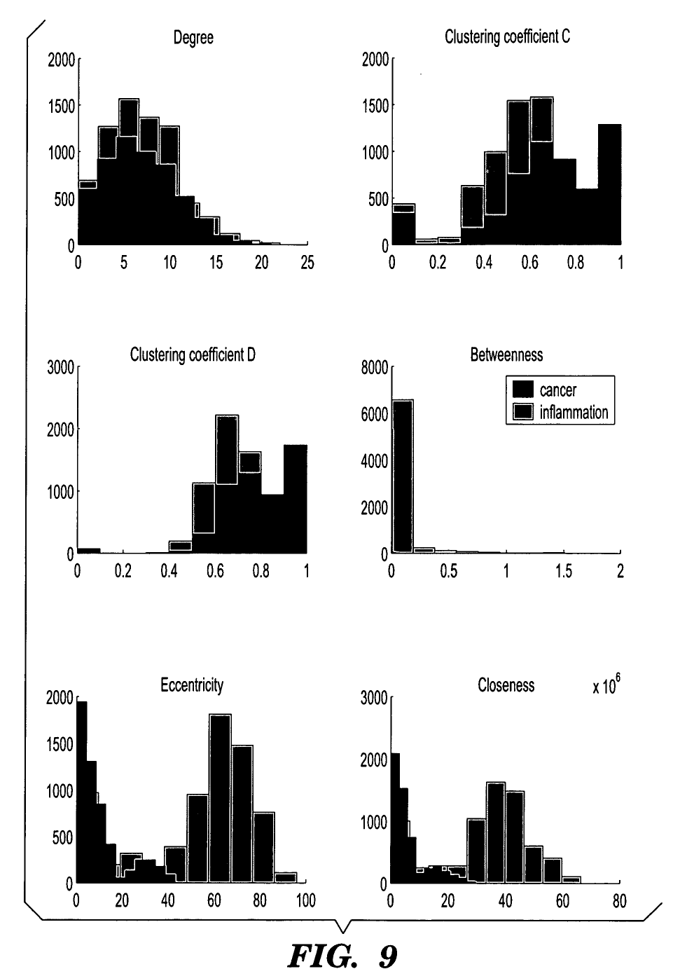

Next, the cell-graphs extracted from the cancerous tissues are compared to the cell-graphs of three different types of structures, namely the cell-graphs of normal tissue (FIGS. 6-7), the cell-graphs of inflamed tissue (FIGS. 8-9), and randomly generated cell-graphs (FIG. 10). These comparisons will demonstrate that the cell-graphs of cancerous tissues are different than those of the three different types of structures, from which it is concluded that the cell-graph structure of glioma differs from the cell-graph structure of other biological phenomenon.

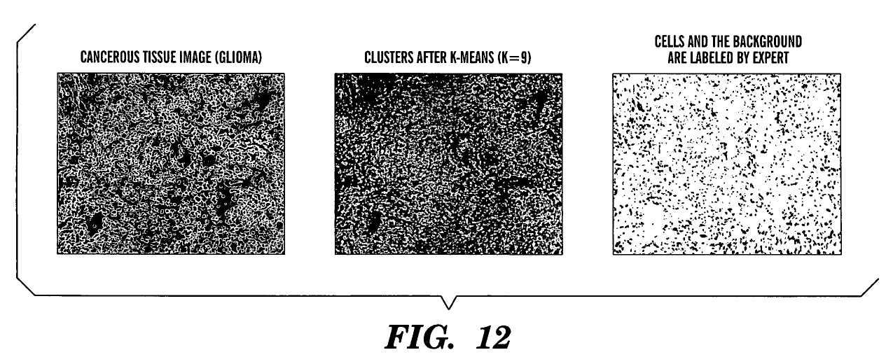

FIG. 6 depicts cell-graphs representing cancer cells from glioma tumor tissue and normal cells, in accordance with embodiments of the present invention. FIG. 13 illustrates a comparison between normal (healthy) tissue and cancer tissue (glioma), in accordance with embodiments of the present invention. In FIG. 6, the sparsity (i.e., density) of the graphs show that the tumor and normal tissues have completely different graphs, which is validated by FIG. 7 depicting data histograms of metrics computed for the cell-graphs representing cancer and normal cells in FIG. 6, in accordance with embodiments of the present invention. The histograms in FIG. 7 are based on five different tissue images of both cancer tissue and normal tissue. The histograms in FIG. 7 are for the metrics of degree, clustering coefficient C, clustering coefficient D, betweenness, eccentricity, and closeness. The difference in the histograms for the cancer and normal cells for each metric provides statistical validation that normal and cancer cells can be distinguished by using these metrics.

FIG. 8 depicts images and cell-graphs representing cancer cells from tumor tissue (upper two sub-figures) and inflammation cells (lower two sub-figures), in accordance with embodiments of the present invention. FIG. 9 depicts data histograms of metrics computed for the image and cell-graphs representing cancer and inflammation cells in FIG. 8, in accordance with embodiments of the present invention. The histograms in FIG. 9 are for the metrics of degree, clustering coefficient C, clustering coefficient D, betweenness, eccentricity, and closeness. FIG. 9 shows that the metrics for the cancerous and inflamed tissues differ for the indicated metrics. Thus, inflamed tissue and cancerous tissue can be distinguished based on, at least, their respective metrics.

The histograms in FIG. 9 show that it is not as easy as with the histograms of FIG. 7 to distinguish the cancer and inflammation cells. Accordingly, a classifier algorithm was run for cancer and inflammation cells, using a multilayer perceptron with 5 hidden units. Table 1 infra shows its average accuracy results of more than 75 percent on training and testing sets, which indicates that the classification is based on the metric values. If it were random, the accuracy results would be approximately 50 percent for two classes classification. Therefore, the histograms of FIG. 9, combined with the accuracy results in Table 1, show that the graph structure of glioma is different statistically from the graph structure of inflamed tissue.

TABLE 1
Accuracy values of training and test sets
in classifying inflammation and tumor cells.

| | Average | Standard Deviation |
|---|---|---|
| Training Set | 91.23 | 0.08 |
| Test set | 76.83 | 0.10 |

Random graphs of the same size as the cancer subgraph were generated and the aforementioned metrics were computed on them as depicted in FIG. 10. In particular, FIG. 10 depicts data histograms of metrics computed for the cell-graphs representing cancer cells and for randomly generated cell-graphs, in accordance with embodiments of the present invention. The histograms in FIG. 10 are for the metrics of degree, clustering coefficient C, clustering coefficient D, betweenness, eccentricity, and closeness. Note that the clustering coefficient C is markedly greater for the cancer graphs than for the random graphs, and the histograms in FIG. 10 show that a tumor cell-graph is different than the random graph.

A classification algorithm was run to distinguish the cancer and normal cell-graphs as well as the random graphs. Using a multilayer perceptron with 5 hidden units, the accuracy values on the training and test sets (for the three classes of normal, cancer, and random) are given in Table 2. From Table 2, it is concluded that the types of nodes can be determined automatically with approximately 95% accuracy.

TABLE 2
Accuracy values on the training and test sets
for classes: normal, cancer, and random

| | Average | Standard Deviation |
|---|---|---|
| Training Set | 94.98 | 0.05 |
| Test set | 94.52 | 0.08 |

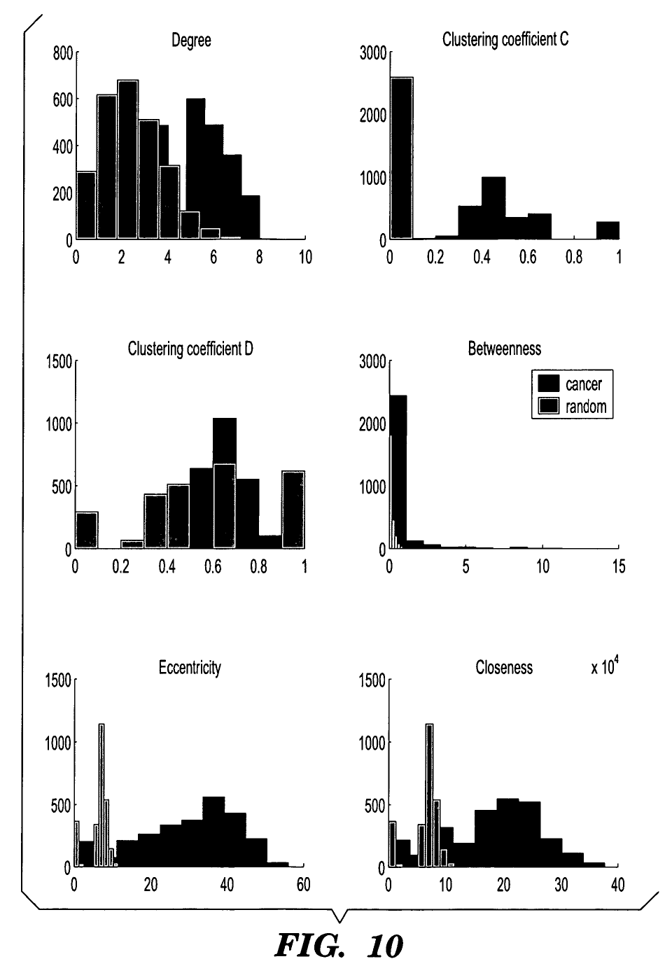

FIG. 11 depicts an image and graph of tissue containing both cancer and normal cells, and a graph classifying cancer and normal cells within the image, in accordance with embodiments of the present invention. The algorithm of the present invention was tested on the images of FIG. 11. These images are not used in training of either K-means algorithm or multilayer perceptrons. In FIG. 11, black regions indicate normal cells, whereas the lighter regions show cancer cells.

As discussed supra, the scope of the present invention classifies a tissue image to determine whether or not the tissue image comprises an abnormal cell type. The abnormal cell type is defined as a cell type that is not a normal healthy cell type. For the experimental data discussed supra, the abnormal cell type is a cancer cell type or an inflammation cell type. Generally, the abnormal cell type may be any cell type that is not a normal healthy cell type.

In addition, the present invention comprises analyzing at least one tissue image by the methods described supra and by the additional methods described infra. The at least one tissue image comprises first tissue images and second tissue images, wherein the first tissue images comprise cells of a first type therein, and wherein the second tissue images comprise cells of a second type therein. At least one metric is computed from the nodes and edges of the generated cell-graphs associated with the first tissue images. At least one metric is computed from the nodes and edges of the generated cell-graphs associated with the second tissue images. The first tissue images are classified to determine whether or not the first tissue images include the cells of the first type, by utilizing the computed at least one metric for the first tissue images. The second tissue images are classified to determine whether or not the second tissue images include the cells of the second type, by utilizing the computed at least one metric for the second tissue images. A determination is made of an average accuracy of said classifying the first tissue images, and a determination is made of an average accuracy of said classifying the second tissue images. Said determinations of average accuracy may be compared and/or displayed. In one embodiment, the cells of the first type are cancer cells and the cells of the second type are normal healthy cells. In one embodiment, the cells of the first type are cancer cells and the cells of the second type are inflammation cells.

In summary, the present invention presents a novel approach for mathematical modeling of biological tissue based on graph theory, wherein said biological tissue may comprise, inter alia, diffuse gliomas. The present invention advances the current computational and mathematical modeling approaches by scaling up the cell-graphs with large number of vertices (i.e., nodes). The graph theoretical model is scalable and used by a machine learning algorithm which can distinguish: (i) cancerous tissue (e.g., gliomas) from surrounding normal tissue; and (ii) cancerous tissue (e.g., gliomas) from inflammation (i.e., tissue comprising inflammation cells).

2. Cell Graphs with Global Metrics

2.1 Introduction

Whereas local metrics (described supra in Section 1) provide information at the cellular level (step 14A of FIG. 1A), the global metrics provide information at the tissue level (step 14B of FIG. 1A). The global metrics are determined by processing the entire cell-graph to capture tissue level information coded into the histopathological images. These global metrics include the average degree, the average clustering coefficient, the average eccentricity, the giant connected component ratio, the percentage of the end nodes, the percentage of the isolated nodes, the spectral radius, and the eigen exponent.

2.2 The Global Metrics

The average degree of a cell-graph is computed as an average of the node degrees. The degree of a node is the number of edges directly connected to the node.

The average clustering coefficient is computed as an average of the local node-excluding clustering coefficient Cᵢ of a node i, which is defined in Equation (1) as Cᵢ=2Eᵢ/(k·(k−1)), wherein k is the number of neighbors of the node i, and wherein Eᵢ is the number of edges between the neighbors of node i.

The average eccentricity is computed as an average of the local eccentricity over entire graph. The local eccentricity of a node i is the length of the maximum of the shortest paths between the node i and every other node reachable from node i. The maximum value of the eccentricity is known as the “diameter” of the graph.

The giant connected component ratio is the ratio of the number of nodes in the giant connected component of the cell-graph to the total number of nodes in the cell-graph. The giant connected component of the cell-graph is the largest set of the nodes, wherein all of the nodes in this largest set are reachable from each other via a path comprising one or more edges.

The percentage of the end nodes is computed as the percent of the nodes which are end nodes. An end node is connected to one node and only one node and therefore has a degree of 1.

The percentage of the isolated nodes is computed as the percent of the nodes which are isolated nodes. An isolated node does not have any neighbor nodes and therefore has a degree of 0.

The last two metrics (spectral radius and eigen exponent) are related to the spectrum of a cell-graph. The spectrum of the cell-graph is the set of all eigenvalues of a matrix defined for the cell-graph (see infra Section 4 for a discussion of the adjacency matrix and the normalized Laplacian matrix of the cell-graph). The spectral radius of the cell-graph is defined as a maximum absolute value of the eigenvalues in the spectrum. The eigen exponent is defined as the slope of the sorted eigenvalues as a function of their orders in a log-log scale. As an example, the eigen exponent may be computed on the first largest 50 eigenvalues of each cell-graph.

2.3 Experiments

Experiments were performed using a data set that comprised 646 microscopic images of brain biopsy samples of 60 randomly chosen patients from the pathology archives. All patients were adults with both sexes included. This data set includes samples of 41 cancerous (glioma), 14 healthy, and 9 reactive/inflammatory processes (herein referred to as “inflamed tissues”). For 4 of these patients, there are both cancerous and healthy tissue samples. The training data set comprises 211 images taken from 22 different patients. The testing data set comprises 435 images taken from the remaining 38 patients. Each sample includes a 5-6 micron-thick tissue section stained with hematoxylin and eosin technique and mounted on a glass slide. The images are taken in the RGB color space with a magnification of 100× and each image has 480×480 pixels. After taking the images, the RGB values of the pixels were converted into their corresponding values into the La*b* color space. Unlike the RGB color space, the La*b* color space is a uniform color space and the color and detail information are completely separate entities. Therefore, using the La*b* color space yields better quantization results in these experiments. The La*b* values of the pixels were clustered using a K-means algorithm, where the value of K is 16.

Generation of the cell graph comprises the steps of color quantization (step 12), node identification (step 13A), and edge establishing (step 13B), as described supra in Section 1.

In identifying the nodes of the cell-graph (step 13A), two control parameters were utilized: the grid size and the node-threshold. A grid size of 6 (i.e., 6×6 pixels in each grid entry), which matches the size of a typical cell in the magnification of 100×, was utilized. The node-threshold determines the density of the nodes in a cell-graph, because the nodes are those grid entries with probability values (i.e., the average of the pixel values in the grid entry) greater than the node-threshold. A larger node-threshold produces sparser cell-graphs, whereas a smaller node-threshold makes the assignment of the nodes more sensitive to the noise arising from misassignment of “cell” classes in the color quantization step. A node-threshold value of 0.25 was used and yielded dense enough cell-graphs while eliminating the noise. In establishing the edges of the cell-graph (step 13B), α=3.6 was used and produced dense enough cell-graphs to capture the distinguishing properties of these cell-graphs.

With respect aforementioned experiments performed with 646 images of brain tissue samples from 60 patients, Table 3 depicts the accuracy in classifying cancerous tissue, healthy tissue, and inflamed tissue, as well as the overall accuracy, using the aforementioned global metrics.

TABLE 3

| | Training Set Accuracy | Testing Set Accuracy |
|---|---|---|
| Overall | 95.93 ± 1.14 | 94.68 ± 0.71 |
| Cancerous | 93.95 ± 1.46 | 94.00 ± 0.79 |
| Healthy | 100.00 ± 0.00 | 96.30 ± 1.16 |
| Inflamed | 95.02 ± 2.03 | 92.19 ± 1.90 |

Classification accuracy levels of 92-95%, using global metrics, are depicted in Table 3. Note that 94.68% accuracy is obtained on the overall testing samples; the percentages of correct classification of the testing samples of healthy, cancerous, and inflamed tissues are 96.30%, 94.00%, and 92.19%, respectively. In contrast, accuracy levels of 83-88%, using local metrics, have been determined by the inventors of the present invention.

Classification at the cellular level, using local metrics, determines whether the tissue is correctly classified at the tissue level by examining the percentage of the nodes with correct classes. If this percentage of the nodes with correct classes is larger than an assumed N percent, the tissue is classified correctly; otherwise the issue is misclassified, which is an indirect way of tissue classification necessitating setting an appropriate value for N. With global metrics, however, the feature set in the classification introduces a direct way of tissue classification and eliminates the need of setting a value of N.

3. Cell Graphs with Weighted Edges

3.1 Introduction

In the Section, the computational histopathological method is extended to include complete cell-graphs (CCG) with weighted cell-nodes and weighted cell-edges constructed from low-magnification tissue images for the mathematical diagnosis of brain cancer (malignant glioma). This CCG method of the present invention employs complete topological information available in such tissue images, including the cell cluster size and the Euclidean distance calculated deterministically for every possible pair of clusters, without loss of any spatial information. As a result, the CCGs may outperform the incomplete-unweighted graphs in the classification of glioma based on the distinctive topological properties of its self-organizing malignant cells, with high accuracy.

3.2 Methodology

The use of complete cell-graphs (CCG) of cancer with weighted cell-nodes and weighted cell-edges comprises identifying the cell clusters on a tissue image to construct their cell-nodes and compute the spatial dependency between every pair of such nodes (any possible combination of two cell clusters) to extract their cell-edges. Instead of unit weights, the cell-nodes and cell-edges are assigned fractional weights as a function of the cell clusters size and the Euclidean distance between the corresponding cell clusters, respectively. This technique relies on the distinctive topological properties of self-organizing cancer cells, rather than the exact distribution and location of each cell. The CCG method inherently eliminates the need for the exact loci of the cells, since the CCG method makes use of the cell clusters rather than the individual cells, where the coarse loci of the cells suffice. Furthermore, the CCG method is likely to be immune to noise, since the CCG method does not use the intensity values of the pixels directly in the feature extraction or the gray-scale dependencies between the pixels. Thus the CCG method relies on the dependency between the identified cell-nodes (rather than between the pixels) in the feature extraction and, hence, the results from using the CCG method are not affected by the noise below a threshold.

The methodology described supra in Sections 1 and 2, of using incomplete-unweighted cell-graphs, statistically utilizes a fraction of the topological information available on the biopsy image. In the incomplete-unweighted cell-graph method, the existence of an edge (with a weight of unity) between the nodes is probabilistically determined (see infra Equations (3)-(4) and the description thereof in Section 1). Once assigned, all of the edges of the unweighted cell-graph are considered to have the same level of impact in the metric calculation due to their fixed unit weights, so that all topological information available on the biopsy image is not utilized.

In contrast, the complete cell-graph method encodes into the edge weights the complete spatial information for every possible pair of cell clusters in the tissue, without losing any topological information that the specimen provides at the cellular level. Thus, the structure of the tissue fully contributes to the final decision of cancer diagnosis, and the sensitivity of the cancer diagnosis is correspondingly improved, as experimentally shown infra.

The complete cell-graph with weighted cell-edges deterministically connects every pair of the cell-nodes, thereby facilitating an embodiment having a large total number of cell edges e.g., approximately 8,000,000 edges for approximately 4,000 cell-nodes in a tissue image of 480×480 pixels (i.e., n(n−1)/2 edges for n nodes in general). In order to connect every cell-node pair, the edges are also assigned fractional weights based on the Euclidean distances between the node pairs.

To identify cell-nodes, pixels are classified as either “cell” or “background” according to their color information. The probability P_{C}, which is the ratio of the number of pixels labeled “cell” to the total number of pixels in the grid entry, is calculated for each grid entry placed on the pixels of the image. In step 13A of FIG. 1A described supra, the grid entries with the probability P_{C} greater than a node-threshold are considered to be the cell-nodes (i.e., “nodes”) of the cell-graph. In the complete cell-graph method, a node weight (i.e., the weight of each cell-node) is assigned the value of the probability P_{C}, wherein the determination of P_{C} has been discussed supra in conjunction with step 13A of FIG. 1A. With the use of such weighted cell-nodes, the information on the cell cluster size (i.e., how may cell pixels make up a particular cluster) is also represented in the resulting cell-graph, which is compatible with tissue images taken only with 100× magnification such that the details of a cell are not fully resolved. Yet, the lumpy behavior of the cell clusters contribute to the formation of the cell-graph and ultimately to the successful diagnosis of cancer, despite the relatively low magnification of the tissue images.

An edge E(u,v) is defined between the nodes (u and v) in each pair of nodes. In implementation of step 13B of FIG. 1A for the complete cell-graph method, the edge weight W_{E}(u,v) is a function of the Euclidean distance d(u,v) between these these two nodes u and v. In one embodiment, W_{E}(u,v) proportional to d(u.v).

The edge weights are used in the computation of the local and global metrics. Without defining the edges weights, it is not possible to define the distinctive graph metrics for complete graphs. For example, for unweighted-complete graphs, the degree of every node is equal to the number of nodes minus one. By retaining every edge and weighting the edges, the complete cell-graph method does not require the parameter α for assigning edge weights as used in Equations (3) and (4) with the unweighted edge methodology described supra for Sections 1 and 2. Hence, the complete cell-graph method decreases the number of free parameters by eliminating the need to assign α.

The global metrics used in step 14B of FIG. 1A for complete-weighted cell-graphs may differ from the global metrics described supra in Section 2 for incomplete-unweighted cell-graphs. In particular, the global metrics used in step 14B of FIG. 1A for complete-weighted cell-graphs are: average degree, average eccentricity, average node weight, the most frequent edge weight, the spectral radius (i.e., the largest absolute value of the eigenvalues in the spectrum), the second largest absolute value of the eigenvalues in the spectrum, and the eigen exponent.

The degree of a node is defined as the sum of the weights of the edges that belong to this node. The calculated degree of the node may be normalized by being divided by the sum of degrees of all nodes of the cell-graph. The average degree of a cell-graph is computed as the average degree of the nodes and may be used as a global metric in the complete cell-graph method. The nodes may be weighted according to the node weights in the computation of the average degree of the cell-graph.

The eccentricity of a node is the length of the maximum of the shortest paths between the node and every other node reachable from the node. The path length is the sum of the edge weights along the path. The average eccentricity is computed as an average of the nodal eccentricities and may be used as a global metric in the complete cell-graph method. The nodes may be weighted according to the node weights in the computation of the average eccentricity.

As stated supra, the node weight for each determined node is the cell probability P_{C}, namely the ratio of the number of pixels labeled “cell” to the total number of pixels in the grid entry of the node. The average node weight is the average of the computed node weights and may be used as a global metric in the complete cell-graph method.

The edges are grouped according to the integral part of their weights; the edges with the same integer part of a weight are put in the same group. Then, the number of the edges in each group is computed and the weight associated to the group with the maximum number of edges is selected as the most frequent edge weight. Therefore, the most frequent edge weight is the most frequent integer part observed in the cell-graph and may be used as a global metric in the complete cell-graph method. For example, with the edge weights of {3.4, 5.2, 3.35, 6.7, 6.7, 3.01}, the most frequent edge weight is 3.

The other global metrics are related to the spectral decomposition of the cell-graph; i.e., the set of the eigenvalues of a matrix associated with the graph (see Section 4 infra for a discussion of the adjacency matrix and the normalized Laplacian matrix). In graph theory, the graph spectrum is closely related to the topological properties of the graph.

The spectral radius is the largest absolute value of the eigenvalues in the spectrum and may used as a global metric in the complete cell-graph method.

The second largest absolute value of the eigenvalues in the spectrum and may be used as a global metric in the complete cell-graph method.

The eigen exponent is defined as the slope of the sorted eigenvalues as a function of their orders in log-log scale and may be used as a global metric in the complete cell-graph method. In an embodiment, the slope of the sorted eigenvalues is based on the third largest and its next largest 30 eigenvalues.

3.3 Experiments

The experiments were conducted on the same samples described in Section 2.3, namely a total of 646 brain biopsy samples of 60 patients in total, which comprised 329 cancerous (malignant glioma) tissue samples of 41 patients, 107 benign inflammatory processes (thereafter referred to as “inflamed”) of 9 patients, and 210 healthy tissue samples of 14 patients (4 patients with both cancerous and healthy biopsies). These 60 patients are randomly chosen from Pathology Department archives in the Mount Sinai School of Medicine, and all patients were adults with both sexes included. The number of patients with the cancerous, inflamed, and healthy tissue samples is 41, 9, and 14, respectively; for 4 patients, we have both the cancerous and healthy tissue samples. These tissue samples comprise 5-6 μm thick tissue section stained with hematoxylin and eosin technique. The images of these tissue samples were obtained by using a Nikon Coolscope Digital Camera. The images are taken in the RGB color space with a magnification of 1box. Prior to segmentation, the RGB values of the pixels are converted to their corresponding values in La*b* color space since this space is a uniform color space that provides separate color and detail information. Each image used in the data set comprises 480×480 pixels.

The preceding data set was divided into training and test sets. Note that the datasets utilized are the same datasets discussed supra in Section 2.3. However, more images from more patients are put into the training set than in Section 2.3, resulting in fewer images of fewer patients in the test set than in Section 2.3. To reflect the real-life situation in the patient distribution of the test set, half of the patients of each type were placed in the test set, and the remaining patients were placed in the training set. For the test set, the number of the biopsy images of each patient is approximately 8 (varying between 6 and 10). For the training set, approximately 8 biopsy images for each cancerous patient were used.

Larger amounts of biopsy samples were used for the healthy and the inflamed, since it might be harder for a neural network to learn the rarer classes if the number of training samples of each class varies significantly between the different classes. Additionally, since the number of available inflamed tissues is less than those of healthy and cancerous samples, the inflamed samples were replicated in the training set.

In summary, 163 cancerous tissues of 20 patients, 150 inflamed tissues of 5 patients (the data set included 75 inflamed tissues prior to the replication), and 156 healthy tissues of 7 patients in the training set were used. In the test set, 166 cancerous tissues of 21 patients, 32 inflamed tissues of 4 patients, and 54 healthy tissues of 7 patients were used. This data set includes some dependent biopsy samples; the samples of the same patient are not independent. It would result in over-optimistic accuracies results for the test set, if different biopsy samples of the same patient were both used in training and testing. To avoid such overoptimistic results, the biopsy samples of entirely different patients in training and test sets were used. Furthermore, the free parameters on the cross-validation sets (within the training set) were optimized without considering the accuracy of the test set.

Complete cell-graphs were generated with a total number of cell-edges as large as approximately 8,000,000 for approximately 4,000 cell-nodes in the tissue image of 480×480 pixels with the 10× magnification.

The classification of the tissues according to their histological properties employs the global metrics (explained in Section 2 and modified for the complete cell-graph method as described supra) as the feature set and an artificial neural network as the classifier. Neural networks are nonlinear models that capture complex interactions among the input data and they tolerate the noisy and irrelevant information. For the experiments analyzed in this section, a multilayer perceptron (MLP) with a number of hidden units is used, wherein the number of hidden units is a free parameter that is optimized by using k-fold cross-validation.

The free parameters (the grid size, node threshold, and number of hidden units) were selected by using 30-fold cross-validation. In k-fold cross-validation, the training set is randomly partitioned into k non-overlapping subsets; the k-1 of the subsets are used to train the classifier, and the remaining subset is used to estimate the performance of the classifier. This is repeated k times for all distinct subsets used in estimating the performance. The classifier performance is estimated as the average of the performances obtained in separate k trials.

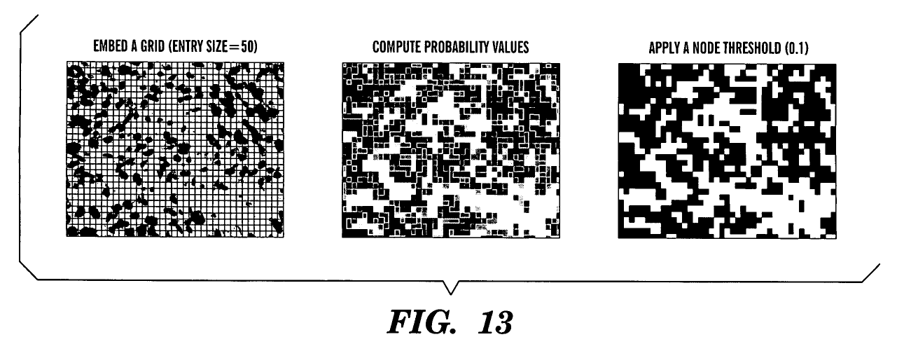

FIGS. 14 and 15 are plots of classification accuracy versus grid size for node-thresholds of 0.25 and 0.50, respectively, for classification of tissue samples using complete cell-graphs, in accordance with embodiments of the present invention. The classification accuracy was obtained in FIGS. 14 and 15 by using 30-fold cross validation on the value of the grid size, for different number of hidden units, namely 4, 8, 12, and 16, in a multilayer perception (MLP). FIGS. 14 and 15 demonstrate that better classification accuracy is obtained for the smaller grid sizes. For the grid sizes below a threshold (e.g., grid values of 4 and 6), the classification accuracies are very close to each other. Especially for larger node-thresholds (e.g., for the node-threshold value of 0.50), the classification accuracy decreases with the increasing grid size in FIG. 14. For smaller grid sizes, the classification results obtained when 16 hidden units are used (the average accuracy obtained on the cross-validation sets and its standard deviation) is shown in Table 4.

TABLE 4

| | Accuracy on Cross-Validation | Accuracy on Cross-Validation |
|---|---|---|
| Grid Size | (Node-Threshold = 0.25) | (Node-Threshold = 0.50) |
| 4 | 96.67 ± 4.55 | 96.44 ± 5.17 |
| 6 | 96.22 ± 6.93 | 95.78 ± 6.43 |
| 8 | 94.00 ± 7.50 | 95.78 ± 6.19 |
| 10 | 93.78 ± 6.54 | 92.22 ± 6.80 |

For the results in Table 4, t-test was performed on difference between the classification accuracy obtained for different parameter sets for t-test significance level of 0.05. The t-test exhibits that there is no significant difference between the accuracy of the following parameter sets {4, 0.25}, {4, 0.50}, {6, 0.25}, {6, 0.50}, and {8, 0.50}, where the first element in each set is the grid size and the second one is the node-threshold. The effects of the node threshold selection have also been investigated with the grid size fixed as 4, which is one of the grid sizes that yields best accuracy results on cross-validation sets in Table 4.

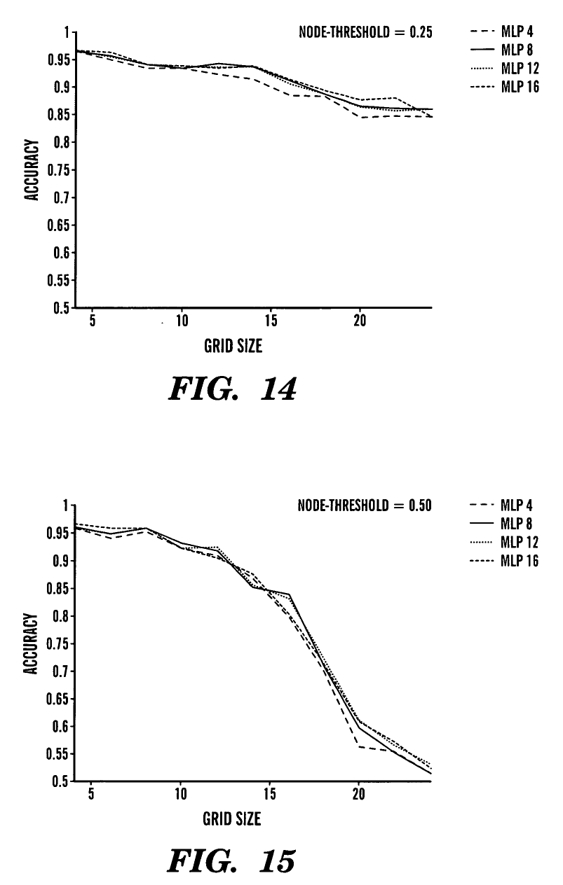

FIG. 16 is a plot of classification accuracy versus node-threshold for the grid size of 4 using 30-fold cross-validation with complete cell-graphs in accordance with embodiments of the present invention. The node-thresholds in FIG. 16 range between 0.25 and 0.99. FIG. 16 demonstrates that, for the smaller values of node-threshold, the classification accuracy is similar regardless of the node threshold value. When the node-threshold is increased to a value above approximately 0.9, the classification accuracy suddenly decreases.

By making use of the 30-fold cross-validation data results, the two sets of parameters ({4, 0.25} and {4, 0.50}) were selected for the grid size and node threshold, respectively. For both of the parameter sets, the number of hidden units was set to 16. For each parameter set, the system was trained by running the multilayer perceptron 30 times. The accuracy as well as the sensitivity and specificity obtained in the test set are given in the first two rows in Table 5.

TABLE 5

| | | | Specificity | Specificity |
|---|---|---|---|---|
| Parameters | Accuracy | Sensitivity | (Inflamed) | (Healthy) |
| {4, 0.25} | 96.93 ± 0.52 | 97.51 ± 0.52 | 91.88 ± 1.76 | 98.15 ± 0.00 |
| {4, 0.50} | 97.13 ± 0.32 | 97.53 ± 0.52 | 93.33 ± 1.08 | 98.15 ± 0.00 |
| {4, 0.50, −4.4} | 95.45 ± 1.33 | 95.14 ± 2.03 | 92.50 ± 1.76 | 98.15 ± 0.00 |

In Table 5, the average accuracy, sensitivity and specificity (obtained over 30 runs) for the complete-weighted cell-graph in the first two rows and incomplete-unweighted cell-graph in the third row. The values in the “Parameters” column are given in the form of {grid size, node threshold} in the first two rows and {grid size, node threshold, edge exponent}in the third row.

In Table 5, the third row presents the accuracy, sensitivity, and specificity obtained using the global metrics extracted for the incomplete-unweighted cell-graphs, in which the cell-graph parameters {the grid size, node threshold, edge exponent} are also selected by using k-fold cross-validation, and the best classification results (on the cross-validation sets) are obtained when these parameters are 4, 0.50, and −4.4, respectively.

The t-test conducted on these classification results exhibits that the accuracy and the sensitivity of the cancer diagnosis are significantly improved by using complete-weighted cell-graphs. For the specificity of the inflamed type tissue, statistically better results are obtained by using complete-weighted cell-graphs with a parameter set of {4, 0.50}. On the other hand, there is no significant difference between the approaches of incomplete-unweighted cell-graphs and complete-weighted cell-graphs with a parameter set of {4, 0.25}. The specificity of the healthy type is the same for both of the cell-graph approaches.

The classification results in this section for the weighted cell-graphs have been compared with the results for nodes classified by using local metrics (cellular level classification—see Section 1) and then a percentage threshold is used to achieve a tissue level classification. The percentage of the correctly classified nodes is compared against a selected threshold to determine whether a tissue is cancerous or not. In this type of classification, increasing the threshold increases the reliability of the system since a larger number of nodes are used in the classification at the tissue level. However, this also results in the decrease of the classification accuracy since a larger number of nodes should then be correctly classified at the cellular level. Therefore, the percentage threshold should be selected considering this trade-off. The use of the global metrics in the cancer diagnosis at the tissue level work resolves this issue and eliminates the need for selecting such a threshold value.

Although the brain cancerous tissue samples are easily distinguished from the healthy ones even with untrained eyes, it is not straightforward to differentiate between the cancerous and the inflamed tissue samples. Despite visual similarity of the test biopsy samples between the cancerous and the inflamed tissue samples, the complete cell-graph method yielded sensitivity of 97.53%, and specificities of 93.33% and 98.15% (for the inflamed and the healthy, respectively) in the cancer diagnosis at the tissue level, because of the strongly distinctive cell-graph properties of each class.

4. Spectral Analysis of Cell Graphs

4.1 Introduction

This present invention utilizes properties of the cell-graphs via spectral analysis (i.e., eigenvalue decomposition) of the cell-graphs. The spectral analysis is performed on: (i) the adjacency matrix of a cell-graph; and (ii) the normalized Laplacian matrix of the cell-graph. It is shown herein that the spectra of the cell-graphs of cancerous tissues are unique and the features extracted from these spectra distinguish the cancerous (malignant glioma) tissues from the healthy and benign reactive/inflammatory processes (referred as to “inflamed tissues”). Experiments on 646 brain biopsy samples of 60 different patients demonstrate that by using spectral features defined on the normalized Laplacian matrix of the cell-graph, 100% accuracy is achieved in the classification of cancerous and healthy tissues. In the classification of cancerous and benign tissues, the experiments disclosed herein yield 92% and 89% accuracy on the testing set for the cancerous and benign tissues, respectively. The graph spectra are also analyzed to identify the distinctive spectral features of the cancerous tissues to conclude that: (i) the features representing the cellular density are the most distinctive features to distinguish the cancerous and healthy tissues; and (ii) and the number of the eigenvalues in the normalized Laplacian spectrum that have a value of 0, which also gives the number of connected components in a graph, is the most distinctive feature to distinguish the cancerous and benign tissues.

4.2 Methodology

The spectrum of a graph is the set of all eigenvalues of its adjacency matrix or its normalized Laplacian matrix. Let G=(V,E) be an undirected and unweighted graph without loops (i.e., self edges) and multiple edges, with V and E being the sets of vertices and edges of the graph G. Note that a loop is an edge that connects a vertex to itself, and the graph with the multiple edges has multiple edges between the same vertices. Let u and v represent nodes of G, and let dᵤ and dᵥ represent the degree of u and v, respectively.

4.2.1 Adjacency Matrix

The adjacency matrix (A) of G is defined by:

$$\begin{matrix}A ( u , v ) = \begin{matrix}1 & if u and v are adjacent ,\end{matrix} \\ = \begin{matrix}0 & otherwise\end{matrix}\end{matrix} \qquad ( 5 )$$

Let λ₀≦λ₁≦ . . . ≦λₙ₋₁ the eigenvalues of the adjacency matrix of a graph G with n vertices. For the adjacency matrix, the following five features in Table 5 may be used as metrics.

TABLE 5

| No. | Feature |
|---|---|
| 1 | The spectral radius, which is defined as a maximum absolute |
| | value of eigenvalues in the spectrum (max \|λᵢ\| for 1 ≦ i ≦ n) |
| 2 | The eigen exponent which is defined as the slope of the sorted |
| | eigenvalues as a function of their orders in log—log scale |
| | (e.g., for the largest (sorted) 50 eigenvalues of each graph) |
| 3 | The sum of the eigenvalues (referred to as “sum”) |
| 4 | The sum of the squared eigenvalue (referred to as “energy”) |
| 5 | The number of the eigenvalues (referred to as “size”) |

The range of these eigenvalues of the adjacency matrix can vary according to the graph in contrast with the eigenvalues of the normalized Laplacian matrix.
Normalized Laplacian Matrix

The normalized Laplacian (L) matrix of G with unweighted edges is defined by:

$$\begin{matrix}L ( u , v ) = 1 & if u = v and {d}_{u} \neq 0 , \\ = - 1 / {( {d}_{u} {d}_{v} )}^{\frac{1}{2}} & if u and v are adjacent , \\ = 0 & otherwise\end{matrix} \qquad ( 6 )$$

The normalized Laplacian (L) matrix of G with weighted edges is defined by:

$$\begin{matrix}L ( u , v ) = 1 - w ( u , v ) / {d}_{u} & if u = v and {d}_{u} \neq 0 , \\ - w ( u , v ) / {( {d}_{u} {d}_{v} )}^{1 / 2} & if u and v are adjacent , \\ 0 & otherwise\end{matrix}$$

where, w(u,v) indicates the edge weight between the nodes u and v.

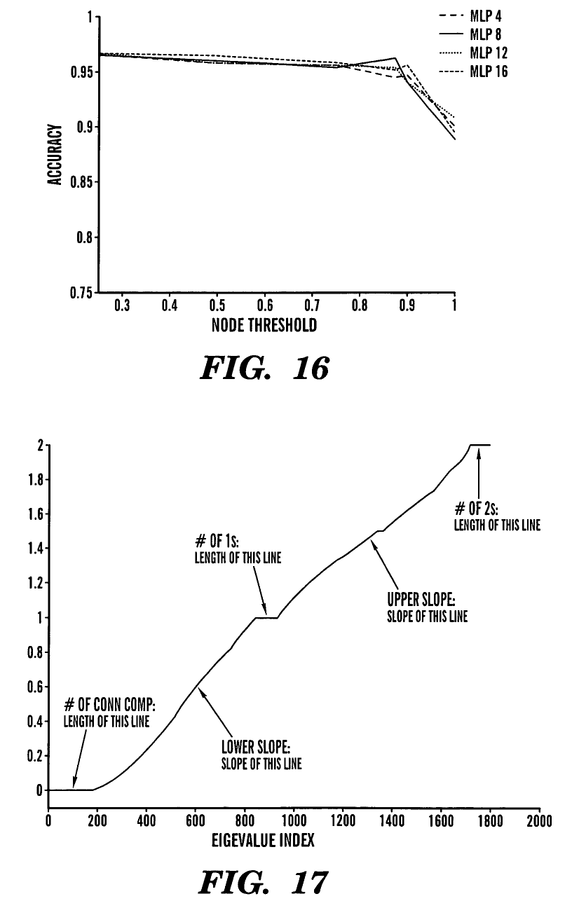

Let 0=λ₀≦λ₁≦ . . . ≦λₙ₋₁≦2 the eigenvalues of the normalized Laplacian of a graph G with n vertices. The following eight features in Table 6 may be extracted from these eigenvalues, the first five of which are illustrated on an exemplary cell-graph of FIG. 17 in accordance with embodiments of the present invention.

TABLE 6

| No. | Feature |
|---|---|
| 1 | The number of the eigenvalues with a value of 0, which gives the number of connected |
| | components in the cell-graph |
| 2 | The slope of a line segment representing the eigenvalues that have a value between 0 and |
| | 1, determined by first fitting a line on these eigenvalues by using linear regression, and |
| | then by computing the slope of this fitted line (referred as “lower-slope) |
| 3 | The number of the eigenvalues with a value of 1 |
| 4 | The slope of a line segment representing the eigenvalues that have a value between 1 |
| | and 2 (referred as “upper-slope”) |
| 5 | The number of eigenvalues with a value of 2, which is greater than 0 if and only if a |
| | connected component of the graph is bipartite and nontrivial |
| 6 | The sum of the eigenvalues Σᵢ λ₁ ≦ n (referred to as “sum”), the equality holds for the |
| | graphs that have no isolated vertices (isolated vertices are vertices with a degree of 0) |
| 7 | The sum of the squared eigenvalues (referred to as “energy”) |
| 8 | The number of the eigenvalues, which is the number of vertices in the graph (referred to |
| | as “size”) |

4.3 Experiments
4.3.1 Data Set Preparation

The experiments were conducted on the microscopic images of brain biopsy samples of randomly chosen patients from the pathology archives. Each of these samples comprises a 5-6 micron thick tissue section stained with hematoxylin and eosin technique and mounted on a glass slide. These patients were adults with both sexes included.

Images of the samples are taken with a magnification of 100× in RGB color space. Prior to color quantization, the RGB values of pixels were converted to their corresponding La*b* values. The La*b* values yield better quantization results, since La*b* is a uniform color space and the color and detail information are completely separate entities. The data set comprises 646 sample images of 60 different patients. This data set comprises 329 samples of 41 cancerous (malignant glioma), 210 samples of 14 healthy, and 107 samples of 9 benign reactive/inflammatory processes. For four of these patients, there were both samples of cancerous and healthy tissues. The biopsy samples were split into the training and test data sets. The training data set comprised 211 sample images of 22 different patients. The test data set comprised 435 sample images of the remaining 38 patients, The images of these patients were not used in the training set.

4.3.2 Parameter Selection

The edge establishing step determines the edges between the nodes in accordance with the probabilistic formulation discussed supra in conjunction with Equations (3) and (4), wherein the probability of an existence of an edge between the nodes u and v is given by P(u,v)=d(u,v)^{-α}, wherein α≧0, wherein d(u,v) is the Euclidean distance between the nodes u and v, and wherein α controls the number of edges of the cell-graph. Smaller values of α yields denser graphs, whereas larger values of α produces sparser graphs.

In the generation of cell-graphs, the following four control parameters were used: (1) the value of K for the K-means clustering algorithm; (2) the grid size (i.e., number of pixels per grid entry; (3) the node-threshold; and (4) the value of α. The value of K in the K-means algorithm should be large enough to represent all of the different tissue parts in the biopsy sample. The value of K was set to 16, since the greater values of K do not significantly improve the quantization results. In identification of the nodes, the grid size was selected to be 6 and the node-threshold was selected to be 0.25. The grid size of 6 matches the size of a typical cell in the magnification of 100×. The node-threshold value of 0.25 eliminates the noise that arises from staining without resulting in significant information lost on the cells for the selected grid size. The value of α range between 2.0 and 4.8 in increments of 0.4.

4.3.3 Results

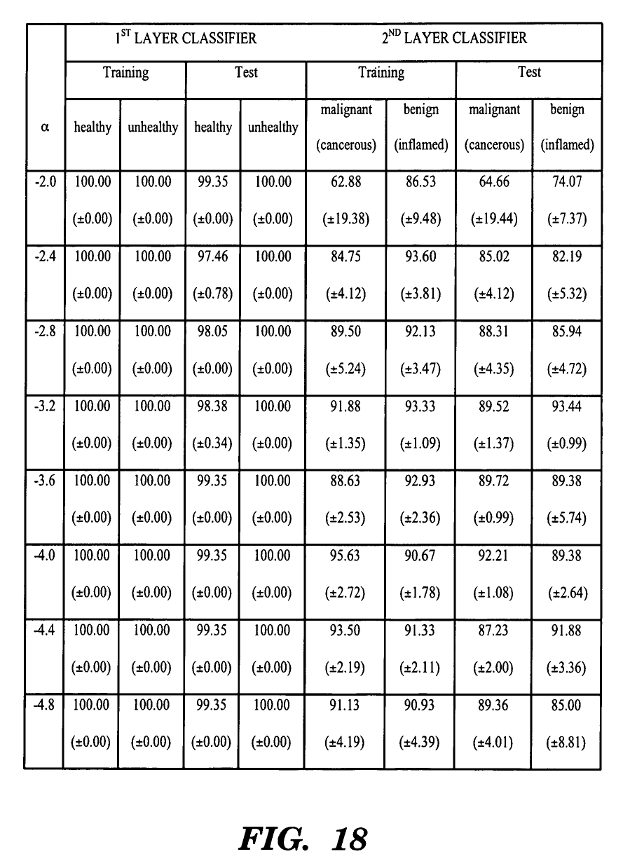

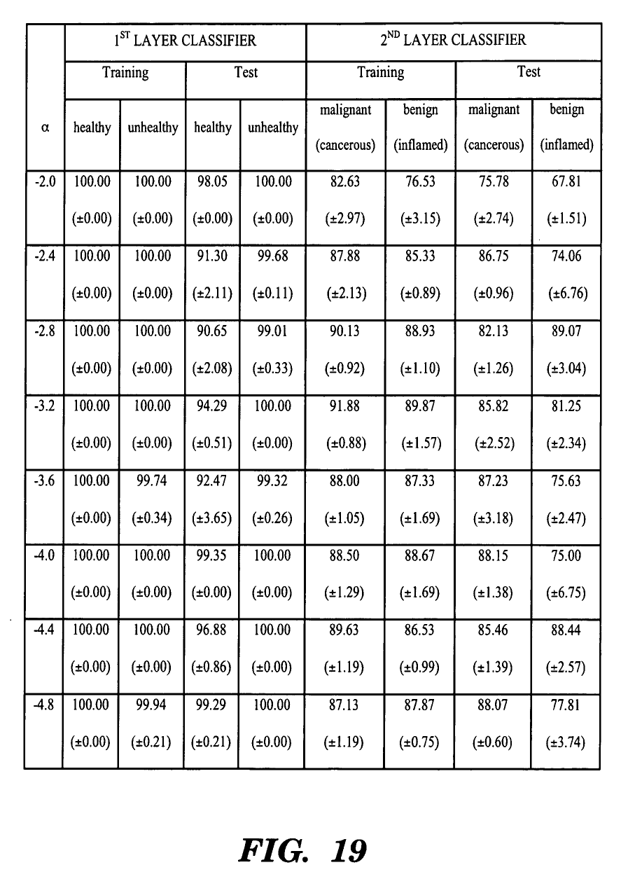

After constructing the cell-graphs, the spectral properties were determined and used in the design of the classifier. The hierarchical classifier was designed to consist of two layers. In the first layer, the classifier is used to decide whether a given sample is healthy or not. If the classifier outputs the sample as healthy, no further classifier is used. Otherwise, if the classifier outputs the sample as unhealthy, the classifier in the second layer is used to decide whether the sample is benign or malignant (i.e., whether it is an inflammatory process or a cancerous tissue). Each classifier is trained separately by using multilayer perceptrons; the number of hidden units for each classifier is selected to be 4. Each of these classifiers is trained in 10 different runs and the average results over these runs are shown in the tables of FIGS. 18-19.

FIG. 18 is a table of first and second layer classifier accuracy as a function of a for the normalized Laplacian matrix spectra of the cell-graphs, in accordance with embodiments of the present invention. The classifier accuracy in FIG. 18 is an average value and its standard deviations. The table of FIG. 18 illustrates that the first layer classifier distinguishes the healthy and unhealthy samples successfully regardless of the value of α. For the unhealthy samples and the healthy training samples, the method yields 100% accuracy. For the healthy test samples, the method yields accuracy greater than 97%. The accuracy of the second layer classifier depends on the value of α that is used in constructing the cell-graphs. For the values of α more than 2.4, the average accuracy greater than 85% for both malignant and benign tissues. Since no further classifier is used when a sample is classified as healthy, the accuracy of the hierarchical classifier for the healthy samples is the same with that of the first classifier. Since the first layer classifier always classifies the unhealthy samples correctly, the accuracy of the hierarchical classifier for the cancerous (malignant) tissues and the inflammatory (benign) processes are the same as those reported by the second classifier. The value of 4.0 of α leads to the least false negative ratio.

FIG. 19 is a table of first and second layer classifier accuracy as a function of a for the adjaceny matrix spectra of the cell-graphs, in accordance with embodiments of the present invention. The classifier accuracy in FIG. 19 is an average value and its standard deviations. The table of FIG. 19 illustrates that the first layer classifier successfully distinguishes the healthy and unhealthy samples, similar to the results for the normalized Laplacian matrix spectra. However, the second layer classifier yields worse results than that of the normalized Laplacian spectra. For the adjacency spectra, the classification accuracy of the cancerous tissues in the testing set is 88.15% at most, whereas the corresponding accuracy of the inflammatory processes is 75.00%. For the normalized Laplacian spectra, these accuracies are 92.21% and 89.38%, respectively. The decrease in the accuracies results from the difficulty to relate the adjacency eigenvalues to the invariants of graph.

4.3.4 Analysis of Individual Features

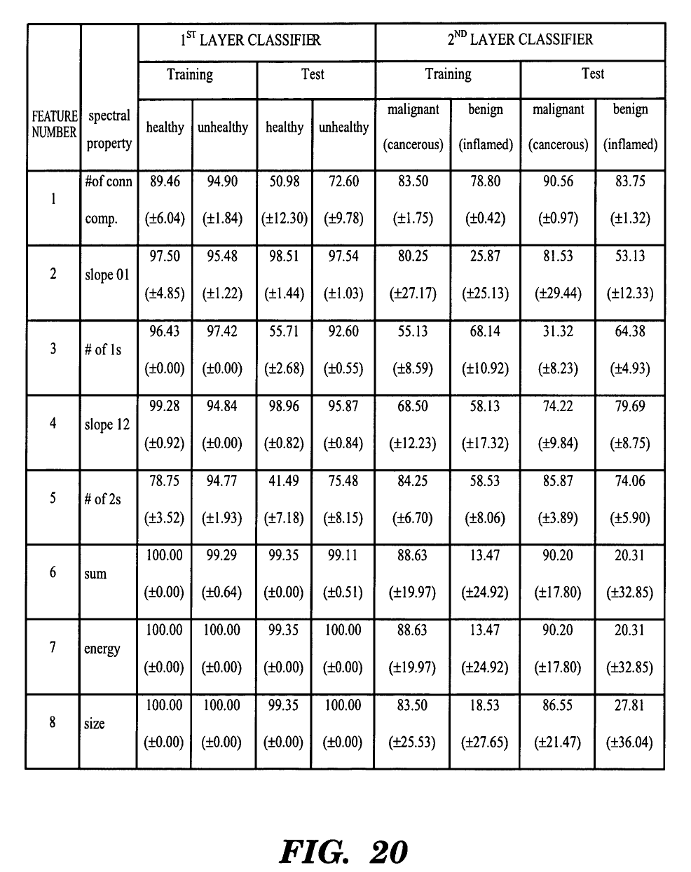

In the experiments, the spectral properties of the cell-graphs are analyzed to identify the most distinctive features. FIG. 20 is a table of classifier accuracy for various spectral properties for the normalized Laplacian matrix spectra of the cell-graphs, in accordance with embodiments of the present invention. Common feature numbers in FIG. 20 and Table 6 refer to the same feature. The classifier accuracy in FIG. 20 is an average value and its standard deviations.

For the first classifier, the features reflecting the cellular density level (i.e., sum (6), energy (7), and size (8)) lead to the same accuracy results when all spectral features are used together. The lower-slope (2) and the upper-slope (4) also yield higher accuracy results for both training and test samples. On the other hand, when the number of the eigenvalues with a value of 0, 1, or 2 (i.e., # of connected components (1), # of 1s (3), or # of 2s (5)) is used alone, the classifier cannot identify the healthy samples; the average accuracy is 40-55% for the healthy testing samples. For the second layer classifier, the density related features fail to distinguish the malignant and benign tissues as opposed to the case of the first classifier. Although these features yield high accuracy results for the malignant (cancerous) tissues, it yields very low accuracy results for the benign (inflamed) tissues. This indicates that the classifier cannot learn how to distinguish these two classes by using a density related feature and it assigns the cancerous class to almost every sample. For this classifier, the most distinctive feature is the number of connected components in a cell-graph which is captured by the number of zero eigenvalues in the Laplacian matrix. It leads to accuracy greater than 85% for the malignant class and accuracy greater than 78% for the benign class on the average. The connected components in a graph can be considered as the cell clusters in a tissue. Therefore this feature is an indicator of the pattern of the cluster formation in the cells. This feature will be analyzed for different α values to clarify its effect on the second layer classifier.

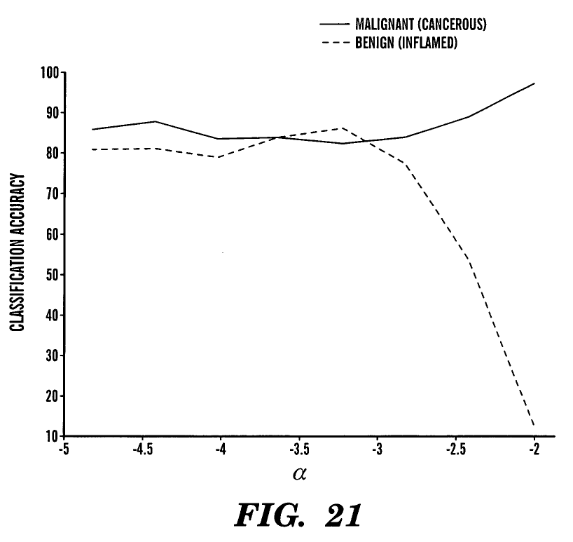

FIG. 21 is a plot of the classification accuracy versus α when the second layer classifier uses only the connected component (1) as its feature, in accordance with embodiments of the present invention. In FIG. 21, there is a drastic drop in the accuracy of benign samples for a less than 2.8. The classifier tends to classify every sample to be malignant. This observation is consistent with the accuracy when the classifier uses all the features (FIG. 18).

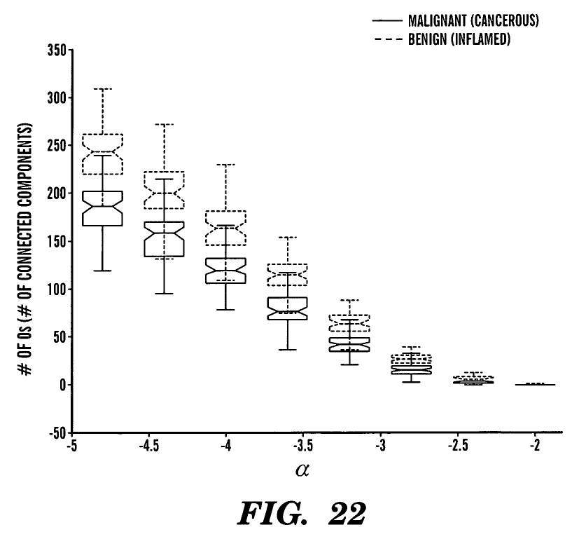

FIG. 22 is a box and whisker plot which illustrates the distribution of the number of the connected components of the cell-graphs for malignant and benign classes, in accordance with embodiments of the present invention. Each box in the whisker plot of FIG. 22 shows the lower quartile, median, and upper quartile values and the whiskers show the extent of the rest of the data. FIG. 22 illustrates that the distributions of this feature are very similar for the malignant and benign classes for α less than 2.8. As a increases, the cell-graph construction method produces denser graphs with almost every vertex (i.e., node) being connected to each other. Therefore, the number of connected components decreases towards 1 for both malignant and benign tissues. Thus, the cluster formation of the cells in malignant and benign tissues should be different, because the number of connected components is closely related to the formation of cell clusters in a tissue and because the classifier cannot correctly classify the samples the distinctive property of this feature is removed by decreasing α.

Based on the preceding experimental results, it is concluded that the spectra of the cell-graphs of cancerous tissues have different characteristics than those of healthy and benign tissues. Although both the adjacency and the normalized Laplacian spectra of these graphs successfully distinguishes the cancerous tissues from the healthy ones, the normalized Laplacian spectra perform better to distinguish the cancerous tissues from the benign ones. The experiments on the normalized Laplacian spectra demonstrate that although it is sufficient to use the spectral properties reflecting the cellular density level for distinguishing the healthy and unhealthy tissues, the spectral properties reflecting the cluster formation in the cells should be used for distinguishing the malignant and benign tissues.

5. Automated Tissue Diagnosis

5.1 Introduction

The present invention comprises computational tools in conjunction with tissue modeling, including computational tools for implementing the methodology decribed supra in Sections 1-4. The computational tools relate to:
1) a computational system based on cell-graphs that can reliably identify cancerous tissue and distinguish it from normal and reactive non-neoplastic conditions using routinely stained histopathological images of individual tumors, focusing on malignant gliomas of the central nervous system;
2) a computational system that can reliably model and separate different phases of glioma growth and progression, (e.g, low-grade vs. high-grade malignant glioma; circumscribed glioma vs. diffuse infiltrating glioma); and
3) a computational system for analyzing the correlation between cell-graph measurements and specific pathology-based and molecular measures (such as MIB-1 proliferation index, 1p/19q mutations) as the basis for developing diagnostic/prognostic tools that are complementary for these traditional measures.
   5.2 Methodolgy

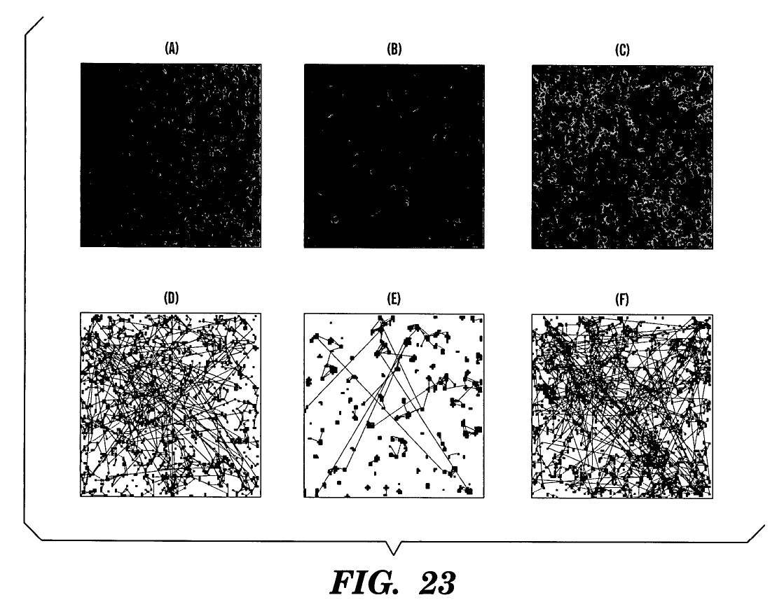

As discussed supra, the cell-graph methodology of the present invention is capable of differentiating different tissue types such as cancerous tissue, healthy tissue, and inflamed non-cancerous tissue. FIG. 23 depicts images illustrating differences in tissue samples and their associated cell-graphs, in accordance with embodiments of the present invention.

FIGS. 23(a), 23(b), and 23(c) respectively show brain tissue samples that are (a) cancerous (gliomas), (b) healthy, and (c) inflamed but non-cancerous. FIGS. 23(d), 23(e), and 23(f) show the cell-graphs corresponding to the tissue image of FIGS. 23(a), 23(b), and 23(c), respectively. While the number of cancerous and inflamed tissue samples appear to have similar numbers and distributions of cells, the structure of their resulting cell-graphs respectively shown in FIG. 23(d) and FIG. 23(f) are dramatically different. The algorithms of the present invention capture these differences and therefore distinguish these cases at the tissue level.

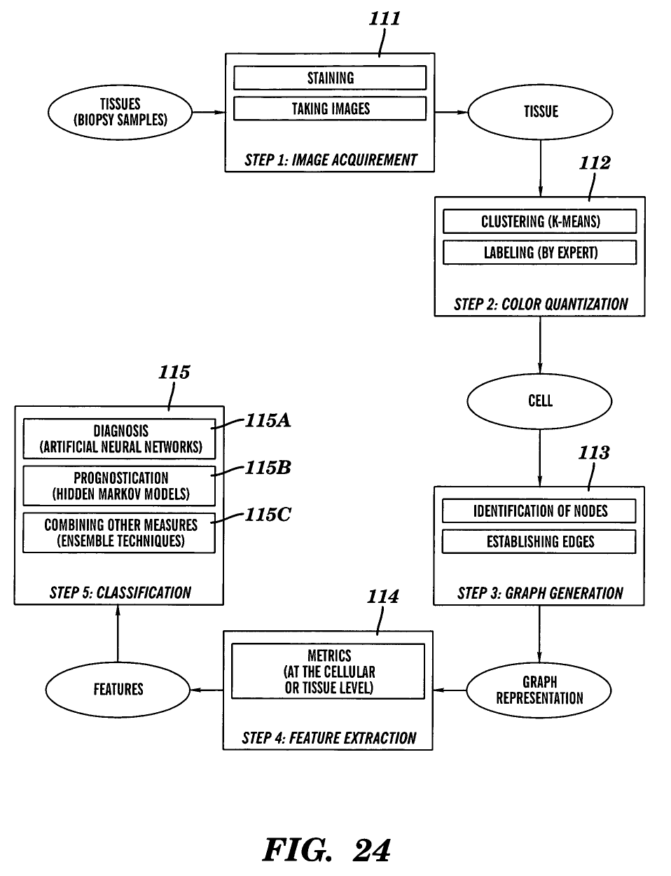

FIG. 24 is a flow chart depicting methodology for tissue modeling, in accordance with embodiments of the present invention. The flow chart of FIG. 24 is similar to the flow chart of FIG. 1A, and steps 111-114 of FIG. 24 are the same as steps 11-14 of FIG. 1A, respectively.

FIG. 25 depicts images representing a methodology for graphically representing cells of biological tissue, in accordance with embodiments of the present invention. FIG. 25, which relates to steps 111-113 of FIG. 24 for generating a cell-graph, is analogous to FIG. 5 (discussed supra) except that the images in FIG. 25 have higher degree of spatial resolution than does FIG. 5.

FIG. 25(a) shows an original tissue image from a cancerous tissue sample. FIG. 25(b) depicts black and white pixels of the tissue image of FIG. 25(a) respectively represented a binary 1 (cell) and binary 0 (background). FIG. 25(c) depicts a grid on the processed image of the black and white pixels of FIG. 25(c). FIG. 25(d) shows the result of averaging the pixel values of 1 and 0 within each grid entry in FIG. 25(c) to compute the probability of the grid entry being a cell. Here different gray levels indicate the probability values. FIG. 25(e) show cell nodes resulting from application of a node-threshold to the probability of each grid entry being a cell. FIG. 25(f) depicts edges selectively generated between nodes of FIG. 25(e) by the methodology described supra in conjunction with Equations (3) and (4).

Returning to FIG. 24, step 115 of FIG. 24 includes steps 115A, 11 5B, and 11 5C, and step 115A of FIG. 24 is the same as step 15 of FIG. 1A.

Step 115B of FIG. 24 pertains to the modeling and studying the interaction and dependencies between local and global graph metrics for understanding prognostication of cancer at the cellular-level and tissue-level, respectively. Using the information on the progress of cancer in the time domain (e.g., tissue samples obtained from different time instances, the evolution dynamics of cancer can be studied. Hidden Markov Models (HMM) can be used to model and learn the complementary information between tissue-level and cellular-level behavior. HMM enables one to infer a likely dynamical system (e.g., the most likely dynamical system) from the observable sequence of HHM outputs, thus providing for a model for the underlying process. The output of the system corresponds to tissue-level information captured by a cell-graph. An objective is to posit the cell-level dynamics by observing the evolution of cell-graphs. This translates in HMM that given a sequence of outputs (i.e., cell-graphs), a likely sequence of states (cell-level behavior) producing these outputs may be inferred. The HMM can also be used to predict the next observation (i.e, a continuation of the sequence of observations).

Step 115C of FIG. 24 pertains to combining cell-graphs with other complementary data extracted from different types of measurements. For example, sensor fusion aims to reduce the uncertainty by combining different types of measurements obtained from multiple sensors. This combination can be done at the data-level, feature-level, or decision-level. Specifically, it is possible to use the feature-level fusion; the cell-graph metrics can be combined with the features defined for the pathology-based and molecular measurements. It is also possible to use the decision-level fusion; a decision is made on each type of measurement, and these decisions are combined subsequently. In literature, there are available ensemble techniques for decision-level fusion, such as voting [J. Kittler, M. Hatef, R. P. W. Duin, and J. Matas, “On combining classifiers”, IEEE Transactions on Pattern Analysis and Machine Intelligence, 1998, 20:226-239], stacked generalization [D. H. Wolpert, “Stacked generalization”, Neural Networks, 1992, 5:241-259], and mixture of experts [R. H. Wolpert, “Stacked generalization”, Neural Networks, 1992, 5:241-259]. Although the different measurements may be combined to improve the overall accuracy, it sometimes produces worse results in practice because of inaccurate or biased data. If such a case emerges, instead of combining all measurements, selection of the most appropriate measurements or a set of such measurements can be employed. In particular, a Principal Component Analysis (PCA) technique may be used to identify the dependencies.

Validation of the methodology has two levels: (i) training and verification in machine learning algorithms; and (ii) correlation of cell-graph based results with those of a pathologist (e.g., a neuropathologist). The classification comprises verification of a learning algorithm. Given the data, it needs to be determined how to split the data into training and test sets. More data used in the training result in better system designs, whereas more data used in the testing result in more reliable evaluation of the system. In one embodiment, the data is separated into two disjoint sets: (i) a training set, and (ii) testing set. If there is no luxury to use a significant portion of the data as the test set, k-fold cross-validation can be used. K-fold cross validation may be employed to randomly partitions the data size into k groups, followed by using k-1 groups to train the system with the remaining group to estimate the error rate. This procedure is repeated k times such that each group is used for testing the system. Leaving one sample out is a special case of the k-fold cross-validation where k is selected to be the size of the data; therefore only a single sample is used to estimate the error rate in each step.

5.3 Data Analysis

The methodology of the present invention may be used to generate and analyze any of the following correlations:
1) Neoplastic vs. non-neoplastic (gliosis, inflammation, radiation change)
2) Tumor grade comparison between pathology diagnosis and image analysis;
3) MIB-1 index vs. image analysis;
4) Deletion status of 1p/19q in oligodendrogliomas vs. image analysis;
5) Oligodendroglioma vs. astrocytoma as diagnostic categories;
6) Circumscribed glioma vs diffuse infiltrating glioma; and
7) Analysis of recurrent tumors with respect to how predictive the pathology diagnosis vs. image analysis results in a retrospective manner. These are patients who have been initially diagnosed with a low-grade glioma, but showed rapid interval growth with recurrence much earlier than expected from a low-grade glioma with gross total resection achieved during initial surgery. This may be due to sampling inadequacy during initial biopsy, or due to the fact that histological parameters are only partially predictive of clinical behavior in a subgroup of tumors. The minimal required information for this comparison comprises the time interval between initial surgery and second surgery, and corresponding pathology diagnoses with ancillary studies such as Ki67 (MIB-1) index, or Chromosome 1p/19q deletions. All this data may be available from the pathology report. Additional relevant data, such as neuroradiological studies and medical treatment (radiation or chemotherapy) may be obtained from a computerized hospital based patient care database by the pathologist.
   5.4 Computer System

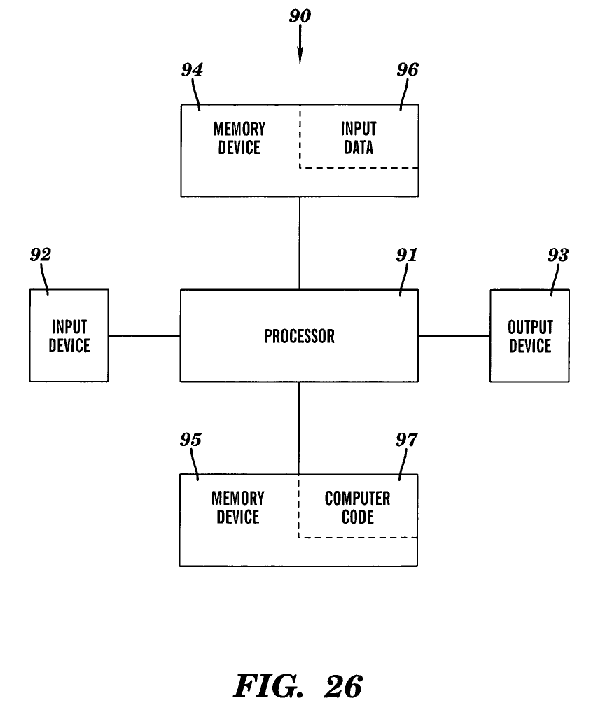

FIG. 26 illustrates a computer system 90 used for tissue modeling in relation to any of the tissue modeling methods described herein, in accordance with embodiments of the present invention. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97 which is a computer program that comprises computer-executable instructions. The computer code 97 includes one or more algorithms for tissue modeling in relation to any of the tissue modeling methods described herein. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 26) may be used as a computer usable medium (or a computer readable medium or a program storage device) having a computer readable program embodied therein and/or having other data stored therein, wherein the computer readable program comprises the computer code 97. Generally, a computer program product (or, alternatively, an article of manufacture) of the computer system 90 may comprise said computer usable medium (or said program storage device).

Thus the present invention discloses a process for deploying or integrating computing infrastructure, comprising integrating computer-readable code into the computer system 90, wherein the code in combination with the computer system 90 is capable of performing a method for tissue modeling in relation to any of the tissue modeling methods described herein.

While FIG. 26 shows the computer system 90 as a particular configuration of hardware and software, any configuration of hardware and software, as would be known to a person of ordinary skill in the art, may be utilized for the purposes stated supra in conjunction with the particular computer system 90 of FIG. 26. For example, the memory devices 94 and 95 may be portions of a single memory device rather than separate memory devices.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

We claim:

1. A method for tissue modeling using at least one tissue image derived from biological tissue, said at least one tissue image having cells therein, said method comprising for each tissue image:
clustering data derived from the tissue image to generate cluster vectors such that each cluster vector represents a portion of the tissue image;
generating cell information, comprising assigning a cell class or a background class to each of the cluster vectors; and
generating a cell-graph for the tissue image from the generated cell information, said generating the cell-graph comprising generating nodes and edges of the cell-graph, said edges connecting at least two of the nodes together, each node representing at least one cell of the biological tissue or a portion of a single cell of the biological tissue.

2. The method of claim 1, wherein said clustering is performed by executing a K-means algorithm in application to the data derived from the sample tissue image.

3. The method of claim 1, wherein the tissue image comprises a two-dimensional array of pixels, and wherein said generating cell information comprises:
assigning the cell class to each pixel associated with the cluster vectors to which the cell class has been assigned; and
assigning the background class to each pixel associated with the cluster vectors to which the background class has been assigned.

4. The method of claim 3, wherein said generating the nodes of the cell-graph comprises:
overlaying a two-dimensional grid on the tissue image, wherein each grid entry of the grid comprises at least one pixel of the array of pixels;
computing a cell probability for each grid entry, wherein the cell probability for said each grid entry is a probability that the grid entry represents one or more cells, said cell probability being a function of the cell class assigned to the at least one pixel in said each grid entry; and
identifying each grid entry to be one of said nodes if the computed cell probability for said each grid entry is greater than a predetermined node-threshold.

5. The method of claim 4, wherein the cell class assigned to the at least one pixel in said each grid entry has a numerical value, and wherein said computing the cell probability for each grid entry comprises computing the cell probability for said each grid entry as being proportional to an average of the numerical value of the cell class assigned to the at least one pixel in said each grid entry.

6. The method of claim 5, wherein generating the edges of the cell-graph comprises for nodes u and v of each pair of generated nodes:
computing a probability P(u,v) that an edge E(u,v) exists between u and v; and
assigning the edge E(u,v) between u and v if P(u,v) exceeds an edge probability threshold.

7. The method of claim 6, wherein P(u,v)=d(u,v)^{-α} such that α is a non-negative real number, and wherein d(u,v) is a Euclidean distance between nodes u and v.

8. The method of claim 6, wherein the edge probability threshold is randomly selected from a uniform probability distribution between 0 and 1 for each pair of generated nodes.

9. The method of claim 6, wherein the method further comprises computing at least one metric from the nodes and edges of the generated cell-graph, and wherein the nodes are equally weighted and the edges are equally weighted for computing the at least one metric.

10. The method of claim 9, wherein computing the at least one metric comprises computing at least one local metric that comprises a value for each node of the cell-graph.

11. The method of claim 10, wherein at least one local metric is selected from the group consisting of degree, node-exclusive clustering coefficient, node-inclusive clustering coefficient closeness, betweenness, eccentricity, and combinations thereof.

12. The method of claim 9, wherein the method further comprises computing at least one global metric from the nodes and edges of the generated cell-graph, and wherein the at least one global metric comprises a value that takes into account all of the nodes of the cell-graph.

13. The method of claim 12, wherein at least one global metric is selected from the group consisting of average degree, average clustering coefficient, average eccentricity, giant connected component, percentage of end nodes, percentage of isolated nodes, spectral radius, eigen exponent, and combinations thereof.

14. The method of claim 5, wherein generating the edges of the cell-graph comprises:
generating an edge E(u,v) for nodes u and v of each pair of nodes of the cell graph;
assigning an edge weight W_{E}(u,v) to each generated edge E(u,v), said edge weight being a function of d(u,v), wherein d(u,v) is a Euclidean distance between nodes u and v; and
assigning a node weight to each node, said node weight being equal to the cell probability of the grid entry represented by said each node.

15. The method of claim 14, wherein W_{E}(u,v) is proportional to d(u,v).

16. The method of claim 14, wherein the method further comprises computing at least one local metric from the nodes and edges of the generated cell-graph, wherein the at least one local metric comprises a value for each node of the cell-graph.

17. The method of claim 16, wherein at least one local metric is selected from the group consisting of degree, node-exclusive clustering coefficient, node-inclusive clustering coefficient closeness, betweenness, eccentricity, and combinations thereof.

18. The method of claim 14, wherein the method further comprises computing at least one global metric from the nodes and edges of the generated cell-graph, and wherein the at least one global metric comprises a value that takes into account all of the nodes of the cell-graph.

19. The method of claim 18, wherein at least one global metric is selected from the group consisting of average degree, average eccentricity, average node weight, most frequent edge weight, spectral radius, second largest absolute value of the eigenvalues, eigen exponent, and combinations thereof.

20. The method of claim 1, wherein the method further comprises computing the eigenvalues of a matrix derived from the cell-graph, and wherein the matrix is selected from the group consisting of an adjacency matrix and a normalized Laplacian matrix.

21. The method of claim 20, wherein the matrix is the adjacency matrix, wherein the method further comprises computing at least one feature based on the computed eigenvalues, and wherein the at least one feature is at least one of the spectral radius of the eigenvalues, the eigen exponent of the eigenvalues, the sum of the eigenvalues, the sum of the squared eigenvalues, and the number of the eigenvalues.

22. The method of claim 20, wherein the matrix is the normalized Laplacian matrix, wherein the method further comprises computing at least one feature based on the computed eigenvalues, and wherein the at least one feature is at least one of the number of the eigenvalues with a value of 0, the slope of a line segment representing the eigenvalues that have a value between 0 and 1, the number of the eigenvalues with a value of 1, the slope of a line segment representing the eigenvalues that have a value between 1 and 2, the number of eigenvalues with a value of 2, the sum of the eigenvalues, the sum of the squared eigenvalues, and the number of the eigenvalues.

23. The method of claim 1, wherein the method further comprises:
computing at least one metric from the nodes and edges of the generated cell-graph; and
classifying the tissue image to determine whether or not the tissue image comprises an abnormal cell type, wherein said classifying the tissue image comprises utilizing the computed at least one metric.

24. The method of claim 23, wherein the abnormal cell type comprise a cancer cell type and or an inflammation cell type.

25. The method of claim 23, wherein the at least one metric comprises at least one local metric, and wherein the least one local metric that comprises a value for each node of the cell-graph.

26. The method of claim 23, wherein the at least one metric comprises at least one global metric, and wherein the at least one global metric comprises a value that takes into account all of the nodes of the cell-graph.

27. The method of claim 23, wherein said classifying the tissue image comprises executing a machine learning algorithm that employs neural networks in conjunction with the at computed metric.

28. The method of claim 1, wherein the at least one tissue image comprises first tissue images and second tissue images, wherein the first tissue images comprise cells of a first type therein, wherein the second tissue images comprise cells of a second type therein, and wherein the method further comprises:
computing at least one metric from the nodes and edges of the generated cell-graphs associated with the first tissue images;
computing at least one metric from the nodes and edges of the generated cell-graphs associated with the second tissue images;
classifying the first tissue images to determine whether or not the first tissue images include the cells of the first type, by utilizing the computed at least one metric for the first tissue images;
classifying the second tissue images to determine whether or not the second tissue images include the cells of the second type, by utilizing the computed at least one metric for the second tissue images; and
determining an average accuracy of said classifying the first tissue images and an average accuracy of said classifying the second tissue images.

29. The method of claim 28, wherein the cells of the first type are cancer cells, and wherein the cells of the second type are normal healthy cells.

30. The method of claim 28, wherein the cells of the first type are cancer cells, and wherein the cells of the second type are inflammation cells.

31. The method of claim 1, wherein the biological tissue is human tissue.

32. The method of claim 1, wherein the method further comprises providing the biological tissue by surgically removing the biological tissue from at least one patient, and wherein said assigning the cell class or the background class to each of the cluster vectors is performed by a pathologist.

33. The method of claim 1, wherein the biological tissue is animal, non-human tissue.

34. The method of claim 1, wherein the biological tissue is plant tissue.

35. A computer program product, comprising a computer usable medium having a computer readable program code embodied therein, said computer readable program code comprising an algorithm adapted to implement a method for tissue modeling using at least one tissue image derived from biological tissue, said at least one tissue image having cells therein, clustering data having been derived from the tissue image to generate cluster vectors such that each cluster vector represents a portion of the tissue image, cell information having been generated by assignment of a cell class or a background class to each of the cluster vectors, said method comprising:
generating a cell-graph for the tissue image from the generated cell information, said generating the cell-graph comprising generating nodes and edges of the cell-graph, said edges connecting at least two of the nodes together, each node representing at least one cell of the biological tissue or a portion of a single cell of the biological tissue.

36. The computer program product of claim 35, wherein the tissue image comprises a two-dimensional array of pixels, and wherein said generating cell information comprises:
assigning the cell class to each pixel associated with the cluster vectors to which the cell class has been assigned; and
assigning the background class to each pixel associated with the cluster vectors to which the background class has been assigned.

37. The computer program product of claim 36, wherein said generating the nodes of the cell-graph comprises:
overlaying a two-dimensional grid on the tissue image, wherein each grid entry of the grid comprises at least one pixel of the array of pixels;
computing a cell probability for each grid entry, wherein the cell probability for said each grid entry is a probability that the grid entry represents one or more cells, said cell probability being a function of the cell class assigned to the at least one pixel in said each grid entry; and
identifying each grid entry to be one of said nodes if the computed cell probability for said each grid entry is greater than a predetermined node-threshold.

38. The computer program product of claim 37, wherein the cell class assigned to the at least one pixel in said each grid entry has a numerical value, and wherein said computing the cell probability for each grid entry comprises computing the cell probability for said each grid entry as being proportional to an average of the numerical value of the cell class assigned to the at least one pixel in said each grid entry.

39. The computer program product of claim 38, wherein generating the edges of the cell-graph comprises for nodes u and v of each pair of generated nodes:
computing a probability P(u,v) that an edge E(u,v) exists between u and v; and
assigning the edge E(u,v) between u and v if P(u,v) exceeds an edge probability threshold.

40. The computer program product of claim 39, wherein the method further comprises computing at least one metric from the nodes and edges of the generated cell-graph, and wherein the nodes are equally weighted and the edges are equally weighted for computing the at least one metric.

41. The computer program product of claim 40, wherein computing the at least one metric comprises computing at least one local metric that comprises a value for each node of the cell-graph.

42. The computer program product of claim 40, wherein the method further comprises computing at least one global metric from the nodes and edges of the generated cell-graph, and wherein the at least one global metric comprises a value that takes into account all of the nodes of the cell-graph.

43. The computer program product of claim 38, wherein generating the edges of the cell-graph comprises:
generating an edge E(u,v) for nodes u and v of each pair of nodes of the cell graph;
assigning an edge weight W_{E}(u,v) to each generated edge E(u,v), said edge weight being a function of d(u,v), wherein d(u,v) is a Euclidean distance between nodes u and v; and
assigning a node weight to each node, said node weight being equal to the cell probability of the grid entry represented by said each node.

44. The computer program product of claim 43, wherein the method further comprises computing at least one local metric from the nodes and edges of the generated cell-graph, and wherein the at least one local metric comprises a value for each node of the cell-graph.

45. The computer program product of claim 43, wherein the method further comprises computing at least one global metric from the nodes and edges of the generated cell-graph, and wherein the at least one global metric comprises a value that takes into account all of the nodes of the cell-graph.

46. An apparatus for tissue modeling using at least one tissue image derived from biological tissue, said at least one tissue image having cells therein, said apparatus comprising for each tissue image:
means for clustering data derived from the tissue image to generate cluster vectors such that each cluster vector represents a portion of the tissue image;
means for generating cell information, comprising assigning a cell class or a background class to each of the cluster vectors; and
means for generating a cell-graph for the tissue image from the generated cell information, said means for generating the cell-graph comprising means for generating nodes and edges of the cell-graph, said edges connecting at least two of the nodes together, each node representing at least one cell of the biological tissue or a portion of a single cell of the biological tissue.

47. The apparatus of claim 46, wherein said means for generating the nodes of the cell-graph comprises:
means for overlaying a two-dimensional grid on the tissue image, wherein each grid entry of the grid comprises at least one pixel of the array of pixels;
means for computing a cell probability for each grid entry, wherein the cell probability for said each grid entry is a probability that the grid entry represents one or more cells, said cell probability being a function of the cell class assigned to the at least one pixel in said each grid entry; and
means for identifying each grid entry to be one of said nodes if the computed cell probability for said each grid entry is greater than a predetermined node-threshold.

48. The apparatus of claim 47, wherein said means for generating the edges of the cell-graph comprises for nodes u and v of each pair of generated nodes:
means for computing a probability P(u,v) that an edge E(u,v) exists between u and v; and
means for assigning the edge E(u,v) between u and v if P(u,v) exceeds an edge probability threshold.

49. The apparatus of claim 48, wherein the apparatus further comprises means for computing at least one local metric from the nodes and edges of the generated cell-graph, and wherein the at least one local metric comprises a value for each node of the cell-graph.

50. The apparatus of claim 48, wherein the apparatus further comprises means for computing at least one global metric from the nodes and edges of the generated cell-graph, and wherein the at least one global metric comprises a value that takes into account all of the nodes of the cell-graph.

51. The apparatus of claim 47, wherein said means for generating the edges of the cell-graph comprises:
means for generating an edge E(u,v) for nodes u and v of each pair of nodes of the cell graph;
means for assigning an edge weight W_{E}(u,v) to each generated edge E(u,v), said edge weight being a function of d(u,v), wherein d(u,v) is a Euclidean distance between nodes u and v; and
means for assigning a node weight to each node, said node weight being equal to the cell probability of the grid entry represented by said each node.

52. The apparatus of claim 51, wherein the apparatus further comprises means for computing at least one local metric from the nodes and edges of the generated cell-graph, and wherein the at least one local metric comprises a value for each node of the cell-graph.

53. The apparatus of claim 51, wherein the apparatus further comprises means for computing at least one global metric from the nodes and edges of the generated cell-graph, and wherein the at least one global metric comprises a value that takes into account all of the nodes of the cell-graph.
